(19) United States
(12) Patent Application Publication
(10) Pub. No.: US 2018/0096398 A1
(43) Pub. Date: Apr. 5, 2018

(54) SYSTEM AND METHOD FOR CROSS PLATFORM PRODUCT LISTING CURATION WITH SOCIAL NETWORK INTEGRATION

(71) Applicant: Informed, Inc., San Francisco, CA (US)

(72) Inventor: Justin Wickett, San Francisco, CA (US)

(21) Appl. No.: 15/281,657

(22) Filed: Sep. 30, 2016

(51) Int. Cl. G06Q 30/02; G06Q 50/00; G06Q 40/04; G06Q 30/08; G06Q 30/06

(52) U.S. Cl. CPC G06Q 30/0276; G06Q 50/01; G06Q 40/04; G06Q 30/0246; G06Q 30/0601; G06Q 30/0269; G06Q 30/0275; G06Q 30/08

(57) ABSTRACT

A system and method for cross platform product listing curation with social network integration is disclosed. A particular embodiment includes: gathering seller information including identifiers of sellers of products listed on at least one peer-to-peer seller platform; obtaining product information corresponding to products listed by the sellers, the product information including product characteristics corresponding to the products listed by the sellers; retrieving potential product buyer information, the potential product buyer information including information indicative of buyer characteristics and buyer contact information of at least one potential buyer; matching the at least one potential buyer with a specific product listed by a specific seller using the product information and the potential product buyer information, the matching including correlating the product characteristics with the buyer characteristics of the matched potential buyer; and initiating contact between the matched potential buyer and the specific seller using the seller information and the buyer contact information.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2015-2016 Informed, Inc., All Rights Reserved.

### TECHNICAL FIELD

This patent application relates to computer-implemented software systems, according to one embodiment, and more specifically to a system and method for cross platform product listing curation with social network integration.

### BACKGROUND

Peer-to-peer used vehicle sales and purchases are difficult to effectively manage. The used vehicle sales and purchase marketplace has a number of inherent vulnerabilities. The used vehicle marketplace is highly volatile. The wide variety of vehicle makes and models presents a challenge even to seasoned appraisers and salespersons in obtaining current valuation information and making accurate appraisals. The widespread use of transitory vehicle incentives causes disruptions in the marketplace. There are typically many factors that can affect key decisions on appraising, qualifying, purchasing, and selling used vehicles. As a result, objective assessment of a vehicle purchase or sale is made difficult and the real value of a transaction is obscured by factors other than the financial objectives of the parties to the transaction. In many cases, the customer feels that a better deal for a similar automobile may exist from another seller; but, that information is difficult to obtain. Sellers can be frustrated when buyers initiate an inquiry regarding a vehicle for sale without having the financial ability to afford the vehicle. Further, there is currently no source for presenting in-market car buyers with curated vehicles for which they are pre-qualified to finance and that match what they're looking to purchase. There is a demand for a system and method that provides relevant information in a current time frame, builds market awareness, and provides accountability for a peer-to-peer used vehicle sales/purchase transaction. Further, there is a need to generate rich, customizable descriptions of the peer-to-peer vehicle inventory; report comparable offers to customers; properly market the products for sale; and monitor the customer's interest and experience in purchasing the products.

### SUMMARY

In various example embodiments, a system and method for cross platform product listing curation with social network integration is disclosed. In the various example embodiments described herein, a computer-implemented tool or software application (app) as part of an ecommerce facilitation system is described to automate product listing curation using the parameters and values required for a particular product or service. As described in more detail below, a computer or computing system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system.

The ecommerce facilitation system of the various embodiments described herein makes peer-to-peer networked commerce (e.g., car buying) easy by creating more trust and better transparency between the buyer and seller through technology. For example, a particular embodiment of the ecommerce facilitation system curates the best like-new vehicles being sold peer-to-peer and verifies that the vehicles haven't been in any accidents, are still under warranty, and are priced competitively against what dealers charge. The ecommerce facilitation system helps sellers to market their vehicles to pre-qualified local buyers who are actively looking to buy a comparable vehicle for sale. The ecommerce facilitation system helps buyers get answers to their questions about the vehicle's history, mechanical condition, fair market value, and purchase financing options for which the buyers are pre-qualified. The ecommerce facilitation system offers these services for free to buyers and sellers. The ecommerce facilitation system can monetize through commissions earned when buyers receive financing.

### BRIEF DESCRIPTION OF THE DRAWINGS

The various embodiments are illustrated by way of example, and not by way of limitation, in the figures of the accompanying drawings in which:

FIG. 1 illustrates example user interface screen snapshots of example embodiments of the cross platform product listing curation system with social network integration;

FIG. 2 illustrates an example embodiment of a networked system in which various embodiments may operate;

FIG. 3 illustrates another example embodiment of a networked system in which various embodiments may operate;

FIG. 4 illustrates a processing flow diagram that illustrates an example embodiment of a method as described herein;

FIG. 5 shows a diagrammatic representation of a machine in the example form of a computer system within which a set of instructions when executed may cause the machine to perform any one or more of the methodologies discussed herein; and

FIGS. 6 through 33 illustrate various example user interface screen snapshots, implemented as a mobile device application, that show the basic elements of the user interface for displaying data and receiving user inputs associated with the cross platform product listing curation system with social network integration in an example embodiment.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for cross platform product listing curation with social network integration are disclosed. In various embodiments, a software application program is used to enable the development and presentation of product listings for targeted buyer groups or audiences on the display screen of a computing or communication system, including mobile devices. As described in more detail below, the computing or communication system on which the described embodiments can be implemented can include personal computers (PCs), portable computing devices, laptops, tablet computers, personal digital assistants (PDAs), personal communication devices (e.g., cellular telephones, smartphones, or other wireless devices), network computers, set-top boxes, consumer electronic devices, or any other type of computing, data processing, communication, networking, or electronic system.

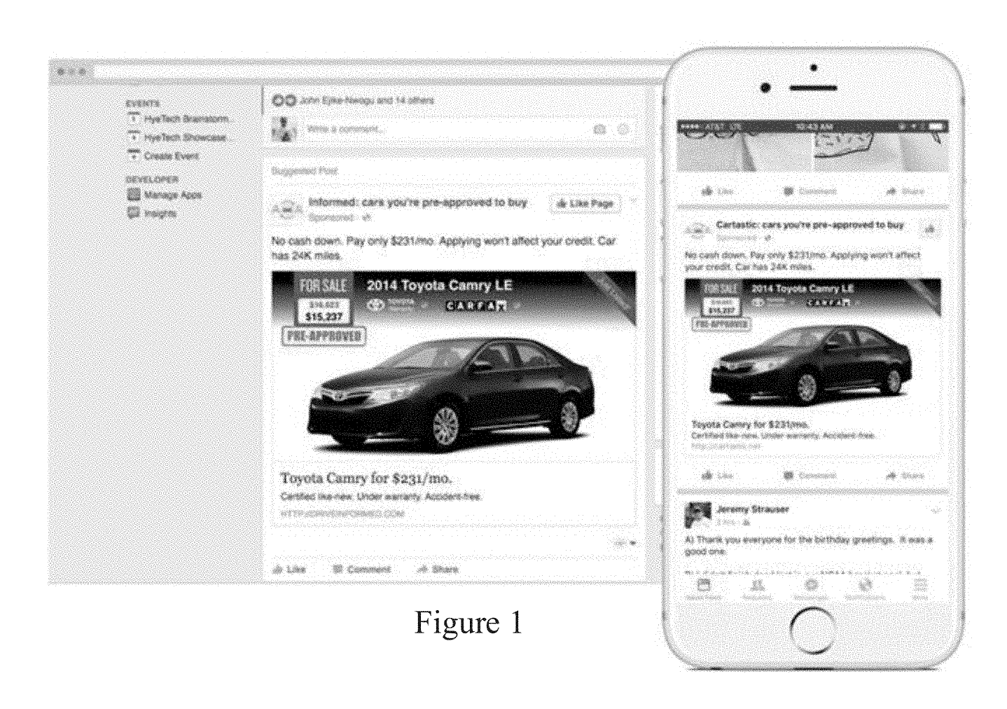

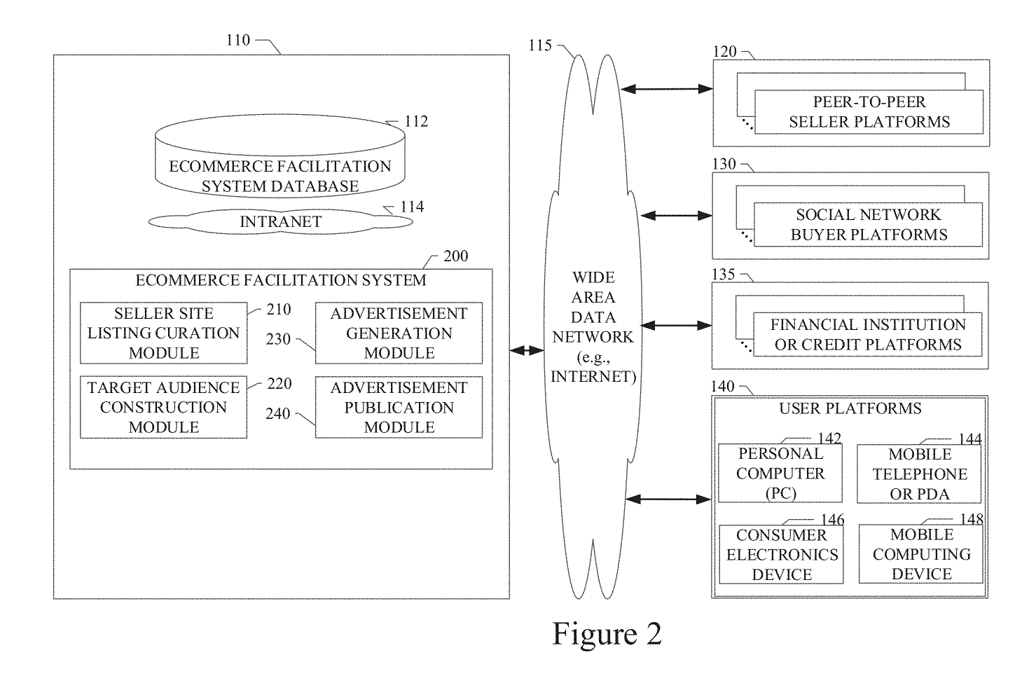

FIG. 1 illustrates example user interface screen snapshots of example embodiments of the cross platform product listing curation system with social network integration. The left side portion of FIG. 1 illustrates a user interface implemented as a web application (web app) with which a user can view, manipulate, and select from among a variety of product listings presented by the web app via the user interface as part of the ecommerce facilitation system. The right side portion of FIG. 1 illustrates a user interface implemented as a mobile application (mobile app) with which a user can view, manipulate, and select from among a variety of product listings presented by the mobile app via the user interface as part of the ecommerce facilitation system. The web app and the mobile app of various example embodiments can have a similar software architecture, which is described for an example embodiment in more detail below in connection with FIG. 2.

FIG. 2, in an example embodiment, illustrates a system for enabling cross platform product listing curation with social network integration. In various example embodiments, an application or service, typically provided by or operating on a host site (e.g., a website) 110, is provided to simplify and facilitate the downloading or hosted use of the ecommerce facilitation system 200 of an example embodiment. In a particular embodiment, the ecommerce facilitation system 200 can be downloaded from the host site 110 by a user at a user platform 140. Alternatively, the ecommerce facilitation system 200 can be hosted by the host site 110 for a networked user at a user platform 140. The details of the ecommerce facilitation system 200 for an example embodiment are provided below.

Referring again to FIG. 2, the ecommerce facilitation system 200 can be in network communication with a plurality of peer-to-peer seller platforms 120 and/or social network buyer platforms 130. The peer-to-peer seller platforms 120 can include websites or other network resources at which information regarding sellers and products (e.g., vehicles) offered for sale is available. The ecommerce facilitation system 200 can be configured to obtain this seller information and product information in a digital or computer-readable form via the network 115. The social network buyer platforms 130 can include websites, social network sites (e.g., Facebook™), or other network resources at which information regarding consumers (e.g., potential product buyers), consumer characteristics, consumer activities, or other buyer information is available. The ecommerce facilitation system 200 can be configured to obtain this buyer information in a digital or computer-readable form via the network 115. The ecommerce facilitation system 200 can also be in network data communication with a plurality of on-line financial institution sites, consumer data or credit reporting platforms, and/or product valuation or rating sites 135. These types of on-line financial institution sites, consumer data or credit reporting sites, and product valuation or rating sites 135 are well known to those of ordinary skill in the art. The ecommerce facilitation system 200 can be configured to obtain potential buyer financial or credit information in a digital or computer-readable form from one or more of the on-line financial institution or credit platforms 135 via the network 115.

One or more of the peer-to-peer seller platforms 120, the social network buyer platforms 130, and the on-line financial institution, credit platforms, or valuation sites 135 can be provided by one or more third party providers operating at various locations in a network ecosystem. It will be apparent to those of ordinary skill in the art that peer-to-peer seller platforms 120 or social network buyer platforms 130 can be any of a variety of networked third party information providers or on-line vendors or merchants as described in more detail below. In a particular embodiment, a resource list maintained at the host site 110 can be used as a summary or list of all peer-to-peer seller platforms 120, social network buyer platforms 130, and on-line financial institution, credit platforms, or valuation sites 135, which users or the host site 110 may visit/access and from which users or the host site 110 can obtain seller data, product data, buyer data, or buyer financial or credit information. The host site 110, peer-to-peer seller platforms 120, social network buyer platforms 130, on-line financial institution, credit platforms, or valuation sites 135, and user platforms 140 may communicate and transfer data and information in the data network ecosystem shown in FIG. 2 via a wide area data network (e.g., the Internet) 115. Various components of the host site 110 can also communicate internally via a conventional intranet or local area network (LAN) 114.

Networks 115 and 114 are configured to couple one computing device with another computing device. Networks 115 and 114 may be enabled to employ any form of computer readable media for communicating information from one electronic device to another. Network 115 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router and/or gateway device acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communication links known to those of ordinary skill in the art. Furthermore, remote computers and other related electronic devices can be remotely connected to either LANs or WANs via a wireless link, WiFi, Bluetooth™, satellite, or modem and temporary telephone link.

Networks 115 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 115 and 114 may also include an autonomous system of terminals, gateways, routers, and the like connected by wireless radio links or wireless transceivers. These connectors may be configured to move freely and randomly and organize themselves arbitrarily, such that the topology of networks 115 and 114 may change rapidly and arbitrarily.

Networks 115 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 115 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 115 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 115 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The peer-to-peer seller platforms 120, social network buyer platforms 130, and/or the on-line financial institution, credit platforms, or valuation sites 135 may include any of a variety of providers of network transportable digital data. The network transportable digital data can be transported in any of a family of file formats and associated mechanisms usable to enable a host site 110 and a user platform 140 to receive seller or product data from a peer-to-peer seller platform 120, to receive buyer data from a social network buyer platform 130, and/or to receive buyer financial or credit information from an on-line financial institution, credit platforms, or valuation sites 135 over the network 115. In one embodiment, the file format can be a Microsoft™ Excel spreadsheet format or a CSV (Comma Separated Values) format; however, the various embodiments are not so limited, and other file formats and transport protocols may be used. For example, data formats other than Excel or CSV or formats other than open/standard formats can be supported by various embodiments. Any electronic file format, such as Microsoft™ Access Database Format (MDB), Portable Document Format (PDF), audio (e.g., Motion Picture Experts Group Audio Layer 3—MP3, and the like), video (e.g., MP4, and the like), and any proprietary interchange format defined by specific sites can be supported by the various embodiments described herein. Moreover, a peer-to-peer seller platform 120, a social network buyer platform 130, and/or an on-line financial institution, credit platforms, or valuation sites 135 may provide a variety of different data sets.

In a particular embodiment, a user platform 140 with one or more client devices enables a user to access data provided by the ecommerce facilitation system 200 via the host 110 and network 115. Client devices of user platform 140 may include virtually any computing device that is configured to send and receive information over a network, such as network 115. Such client devices may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. The client devices may also include other computing devices, such as personal computers 142, multiprocessor systems, microprocessor-based or programmable consumer electronics, network PC's, and the like. The client devices may also include other processing devices, such as consumer electronic (CE) devices 146 and/or mobile computing devices 148, which are known to those of ordinary skill in the art. As such, the client devices of user platform 140 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and a full screen color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript™, EXtensible HTML (xHTML), Compact HTML (CHTML), and the like, to display and/or send digital information. In other embodiments, mobile devices can be configured with applications (apps) with which the functionality described herein can be implemented.

The client devices of user platform 140 may also include at least one client application that is configured to receive product data, buyer data, and/or control data from another computing device via a wired or wireless network transmission. The client application may include a capability to provide and receive textual data, graphical data, video data, audio data, and the like. Moreover, client devices of user platform 140 may be further configured to communicate and/or receive a message, such as through a Short Message Service (SMS), direct messaging (e.g., Twitter™), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Referring again to FIG. 2, the ecommerce facilitation system 200 for an example embodiment is shown to include an ecommerce facilitation system database 112. The database 112 can be used to retain a variety of information data sets including, but not limited to, seller information, product or product listing information, buyer information, buyer financial or credit information, targeted buyer group or custom audience information, advertisement (ad) data, buyer/seller/product analytics, and the like. It will be apparent to those of ordinary skill in the art that the ecommerce facilitation system database 112 can be locally resident at the host site 110 or remotely located at other server locations or stored in network cloud storage.

Referring again to FIG. 2, host site 110 of an example embodiment is shown to include the ecommerce facilitation system 200. In an example embodiment, ecommerce facilitation system 200 can include a seller site listing curation module 210, a target audience construction module 220, an advertisement generation module 230, and an advertisement publication module 240. Each of these modules can be implemented as software components executing within an executable environment of ecommerce facilitation system 200 operating on host site 110 or user platform 140. Each of these modules of an example embodiment is described in more detail below in connection with the figures provided herein.

Referring still to FIG. 2, the ecommerce facilitation system 200 can include a seller site listing curation module 210. The seller site listing curation module 210 can be configured to perform the processing as described herein. Initially, the seller site listing curation module 210 can be configured to establish, by use of a data processor and the data network 115, a data connection with at least one peer-to-peer seller platform 120. Additionally, the seller site listing curation module 210 can be configured to identify sellers of like-new vehicles who self-identify on peer-to-peer seller platforms 120, such as Craigslist™, AutoTrader™, Cars.com™, Ebay™ Motors™, and the like. The seller site listing curation module 210 can be configured to offer to help these sellers sell their vehicles faster by reaching a wider audience of in-market car buyers looking to purchase their vehicle. For example, the seller site listing curation module 210 can be configured to scrape these peer-to-peer seller platforms or dealer platforms for listings of vehicles for sale. Alternatively, a representative of the host 110 can make agreements with the peer-to-peer seller platforms or dealer platforms to enable the host 110 to get the listings of vehicles for sale directly. The seller site listing curation module 210 can be configured to offer this service for free, and can request additional information from the seller. As part of the curation process, sellers can be asked to provide the vehicle identification number (VIN) or vehicle's license plate number of a vehicle for sale so that any past accidents, ownership, maintenance, mileage, and warranties can be reviewed. Sellers are also asked to provide their contact information and social networking profiles so that buyers can check mutual friends and affinity groups shared in common. The seller site listing curation module 210 can be configured to ask sellers to provide the options on their vehicle to verify that the vehicle is indeed priced fairly based on the local market. The seller site listing curation module 210 can be configured to conduct a video interview with the seller and his/her vehicle to note any scratches, dings, and dents that could affect the vehicle's value. Sellers are asked to pledge that their vehicles are mechanically sound outside of normal wear and tear to the best of their knowledge. To back their pledge that the vehicle is indeed as advertised, sellers can agree to pay for a buyer's mechanical inspection should major mechanical issues be uncovered. As a result, the seller site listing curation module 210 can be configured to gather a variety of seller information and product (e.g., vehicle) information related to the products offered for sale by the sellers. The curated seller information and products for sale information can be structured and stored in a searchable sales inventory database. The seller information can include seller contact information, a seller profile, a link to a seller profile on a social network site, a seller rating, and the like. The product information can include a product identifier, product features, product categories or characteristics, condition, price, purchase history, repair/maintenance history, accident history, owner history, warranty history, manufacturer information, mechanical condition, fair market value, and a variety of other product-related information. In this manner, the ecommerce facilitation system 200 can enable honest buyers and sellers to transact with greater trust and transparency.

Referring still to FIG. 2, the ecommerce facilitation system 200 can include a target audience construction module 220. The target audience construction module 220 can be configured to perform the processing as described herein. Initially, the target audience construction module 220 can be configured to establish, by use of a data processor and the data network 115, a data connection with at least social network buyer platform 130. Additionally, the target audience construction module 220 can be configured to partner with Facebook™, Datalogix™, IHS Automotive™, and/or other social network buyer platforms or other network resources 130 at which information regarding consumers (e.g., potential product buyers) is available. The target audience construction module 220 can use the potential product buyer information retrieved from any of the social network buyer platforms or other network resources 130 to match in-market car shoppers (e.g., the potential product buyers) with specific vehicles (or other products) being currently offered for sale by active sellers and sought by the active potential buyers. In an example embodiment, this matching of potential product buyers with active product sellers is performed using a cookie-matching process. As part of the cookie-matching process, the social network buyer platforms or other network resources 130 can establish a pre-agreement with the host site 110 to enable the ecommerce facilitation system 200 on the host site 110 to assist the social network buyer platforms or other network resources 130 in associating the potential product buyers and social network users with specific vehicles (or other products) of interest to the buyers. In a particular implementation, the target audience construction module 220 can be configured to place a cookie (e.g., or other form of retained data object) on each potential product buyer's local client device (e.g., computer, mobile device, etc.) to identify which specific vehicles (or other products) are of interest to the potential product buyers. The target audience construction module 220 can use the potential product buyer information retrieved from any of the social network buyer platforms or other network resources 130 to generate the cookie placed on the corresponding user client device. When the social network user and potential buyer uses an account at one of the social network buyer platforms or other network resources 130, the social network buyer platform or other network resource 130 can retrieve the cookie from the user client device and thereby determine the type of products in which the particular user/buyer is interested. In this manner, the social network buyer platforms or other network resources 130 (e.g., Facebook™) are thereby able to identify which of their users are in-market to purchase a specific type of vehicle (or other product) based on the presence of this cookie and its corresponding data as generated and placed by the target audience construction module 220.

The target audience construction module 220 of the example embodiment can be further configured to programmatically generate target or custom audiences of users of the network resources 130 (e.g., Facebook™) and associated social networking properties based on shared characteristics. For example, the target audience construction module 220 can support the generation and maintenance of one or more user profiles provided by users and potential product buyers. The user profiles can also be automatically obtained from the network resources 130 using the account credentials of the particular user/potential product buyer. The generation and maintenance of user profiles can include support for activities associated with the user profiles and product search information, including storing and retrieving user notes, web sites (URLs), links associated with related tags, search queries, search results, research and notes from other users and community members, related community groups, contacts with vendors, providing localized geographic data for user profiles (e.g., regional or country-specific consumer purchasing patterns), etc. Additionally, the target audience construction module 220 can support social networking functions, including building and maintaining the community groups created by a user, which may be helpful in providing various types of data (e.g., reviews, notes, local services, consumer information, etc.) pertaining to the user profiles and product search information.

In an example embodiment, the target audience construction module 220 can support the management of various contexts associated with a potential product buyer. For example, the target audience construction module 220 can track keyword searches of product listings associated with a context defined by a user profile of a particular consumer. The context can include an association between the user profile data in the user profile and item feature sets related to items in the product listings. The item listings can include listings from a group including products or services or both. The item feature set data and data defining the association between the user profile data in the user profile and item feature sets may be retrieved from the social network buyer platforms or other network resources 130 or from various other remote sources, such as other network sites, other users (e.g., experts or peers), etc. In one embodiment, a user interface object can be provided to enable a user to create a new user profile, selectively add a uniform resource locator (URL) associated with the created user profile, and create notations regarding product searches, research, and general matters associated with the user profile. These functions may be user accessible by many methods known in the art, including a web form interface (HTML or embedded Java) or a stand-alone application interface. For example, a user interface can be provided to allow the viewing and editing of a user profile, various related item listings, item feature sets, contexts, catalogues, inventories, social networks, and review data structures within the ecommerce facilitation system database 112. Various other navigation applications (e.g., an external search engine) may be provided to supplement the search and browsing applications.

As described above, the target audience construction module 220 of the example embodiment can be configured to programmatically generate target or custom audiences of users of the network resources 130 based on shared characteristics. The target or custom audiences can be defined in target or custom audience data sets that specify the characteristics of the particular target or custom audience and the shared user characteristics within each custom audience. The associated user profiles and/or the potential product buyer information retrieved from any of the social network buyer platforms or other network resources 130 can be used to dynamically determine these shared user characteristics. For example, the target audience construction module 220 of the example embodiment can use the dynamically determined user characteristics to group users into discrete target audiences. A few examples of these dynamically determined target audiences are set forth below:
The audience member's likelihood of purchasing a specific vehicle (e.g., an SUV, sedan, Mazda™, BMW™, etc.);
The audience member's geographical location (geolocation) relative to a geolocation of a seller's vehicle of potential interest to the audience member;
The audience member's credit profile and debt-to-income ratios
The audience member's age, gender, and interests

The target audience construction module 220 can be configured to construct these target audiences using data made available by the network resources 130 (e.g., Facebook™) and by drawing correlations between users of the network resources 130 who share particular characteristics of interest. Because many network resources 130 (e.g., Facebook™) do not have the ability to target individuals directly based on credit profile or debt information, the target audience construction module 220 can be configured to obtain such information from various other network sources when creating target audiences. For example, users can provide authorization for access to credit reporting agencies. Financial institutions seeking to better serve their customers can also provide such user financial data in an anonymized manner. The target audience construction module 220 can be further configured to establish, by use of the data processor and the data network, a data connection with at least one financial institution, credit platforms, or valuation sites 135 to retrieve the user/consumer financial data, a list of email addresses and phone numbers, or other sensitive information from financial institutions and to hash or encrypt the data or otherwise anonymize personally identifiable information to protect identities. The hashed or encrypted email addresses and phone numbers can be mapped by the target audience construction module 220 back to the financial characteristics of the particular individuals, such as their bank transaction histories, income, and credit profiles. The target audience construction module 220 can be configured to upload these hashed or otherwise anonymized email addresses and phone numbers to the network resources 130 (e.g., Facebook™) to further refine the target audiences of in-market car buyers. These dynamically determined target audiences can associate users with similar credit profiles, income levels, and debt levels along with similar demographics and purchasing behaviors. In this manner, the target audience construction module 220 can assemble groupings of potential buyers with common characteristics into target or custom audiences by use of information obtained from the buyer platforms or network resources 130 (e.g., Facebook™) user profiles, financial institution, credit platforms, or valuation sites 135, and other networked information sources. Thus, the target audience construction module 220 can retrieve potential product buyer information from at least one buyer platform 130, wherein the potential product buyer information can include information indicative of buyer characteristics and buyer contact information of at least one potential buyer. Additionally, the target audience construction module 220 can match the at least one potential buyer with a specific product listed by a specific seller on at least one peer-to-peer seller platform 120 using the seller information and/or the product information and the potential product buyer information, the matching including correlating the product characteristics with the buyer characteristics of the matched potential buyer. Once the target audience construction module 220 matches the at least one potential buyer with a specific product listed by a specific seller, the target audience construction module 220 can initiate contact between the matched potential buyer and the specific seller using the seller information and the buyer contact information. The contact between buyer and seller can be initiated directly via email or text messaging or initiated via a social network or network resource 130 communication feature.

Referring still to FIG. 2, the ecommerce facilitation system 200 can include an advertisement generation module 230. The advertisement generation module 230 can be configured to perform the processing as described herein. In particular, the advertisement generation module 230 can be configured to programmatically generate advertisement (ad) creatives of each vehicle (or other product) curated by the seller site listing curation module 210 as described above. These ad creatives can be comprised of both text and visuals (e.g., images, videos, slideshows, animations, and the like) and are generated specifically for each target or custom audience defined by the target audience construction module 220 as described above. In an example embodiment, the custom audiences defined by the target audience construction module 220 can be members or users of any of a variety of social networks or network resources 130, such as Facebook™ and/or other social networks. The advertisement generation module 230 can programmatically generate the ad creatives for specific members/users and/or particular custom audiences and make the ad creatives available for display or rendering to the members/users of the particular custom audiences at the social networks or network resources 130. The ad creatives assist car shoppers (or other potential product purchasers) on these social networks or network resources 130 to be more aware of like-new vehicles sold peer-to-peer without any dealer markup that the potential product purchasers may finance through the ecommerce facilitation system 200 of an example embodiment. Because the dynamically-created ad creatives can be targeted to specific members/users or particular custom audiences, the ad creatives are more likely to be successful in promoting product sales. In a particular embodiment, the advertisement generation module 230 can retrieve user/consumer information from database 112 as gathered by the seller site listing curation module 210 and the target audience construction module 220. As a result, the advertisement generation module 230 can use the retrieved user/consumer information to determine the specific types of products in which the particular users/buyers of a particular custom audience are likely to be interested. In particular, car shoppers may learn more about these curated vehicles, including the vehicle make, model, year, and trim along with their mileage and price. The ad creatives give viewers the confidence that they'll be able to obtain financing to purchase the showcased vehicle and insight into what they should expect to pay on a monthly basis given what the example embodiment knows about their personal financial situation. The ad creative also gives viewers visibility into how the vehicle's price compares with the local fair market value for the car. The ad creative also gives its custom audience more transparency into the vehicle's past accident, ownership, maintenance, and warranty history.

Referring still to FIG. 2, the ecommerce facilitation system 200 can include an advertisement publication module 240. The advertisement publication module 240 can be configured to perform the processing as described herein. In particular, after the advertisement generation module 230 dynamically generates ad creatives, which have been personalized for its intended audience as described above, the advertisement publication module 240 can be configured to instruct the social network's or network resource's 130 ad platform to begin displaying the ad creative to its relevant audience as defined by the custom audience data set. The advertisement publication module 240 can be further configured to specify a variable or fixed bid value to pay for each click generated by the users of the custom audience as they view and potentially interact with the ad. Alternatively, the advertisement publication module 240 can allow the social network's or network resource's 130 ad platform determine such bid values based on the bid values other advertisers are willing to pay to reach the same audience.

The advertisement publication module 240 can be configured to report statistics and analytics back to the seller regarding the free-of-charge visibility that his/her vehicle is receiving via the ad creatives generated by the ecommerce facilitation system 200. The statistics and analytics associated with the published ad creatives can also be retained in the database 112. As a result, peer-to-peer sellers can see how many unique in-market car shoppers have viewed their vehicle (or other product). In a manner similar to the target audience construction module 220 as described above, the advertisement publication module 240 can also be configured to initiate contact between a potential buyer and a specific seller using the seller information and the buyer contact information thereby enabling potential buyers interested in a particular vehicle to connect with the seller of the particular vehicle via SMS or email in a way that protects the personal identity and privacy of both the buyer and seller. The advertisement publication module 240 can be further configured to give buyers confidence that they'll be able to obtain the financing as advertised. The advertisement publication module 240 can use the potential buyer's credit or financial profile as generated by the target audience construction module 220 and stored in database 112 to pre-qualify a potential buyer for financing a vehicle. As a result, sellers are given confidence that the buyer contacting them is legitimate and has the means to purchase their vehicle.

As configured and directed by the user via a computer-generated user interface, the example embodiments described herein can automatically: 1) identify sellers of like-new vehicles who self-identify on peer-to-peer seller platforms; 2) use the potential product buyer information retrieved from any of the social network buyer platforms or other network resources 130 to match in-market car shoppers (e.g., the potential product buyers) with specific vehicles (or other products) being currently offered for sale by active sellers and sought by the active potential buyers; 3) create and publish product ad creatives; 4) manage user product inquiries and financing options; 5) manage the publication of the ad creatives to a defined set of targeted recipients in a custom audience and manage the retrieval of feedback from the set of targeted recipients; 6) compile, report, and retain various statistics and analytics associated with the published ad creatives; and 7) manage a variety of other operations related to the generation, configuration, and execution of a system and method for cross platform product listing curation with social network integration. In various example embodiments, the computer-generated user interface can be illustrated in several screen snapshots as illustrated and described below.

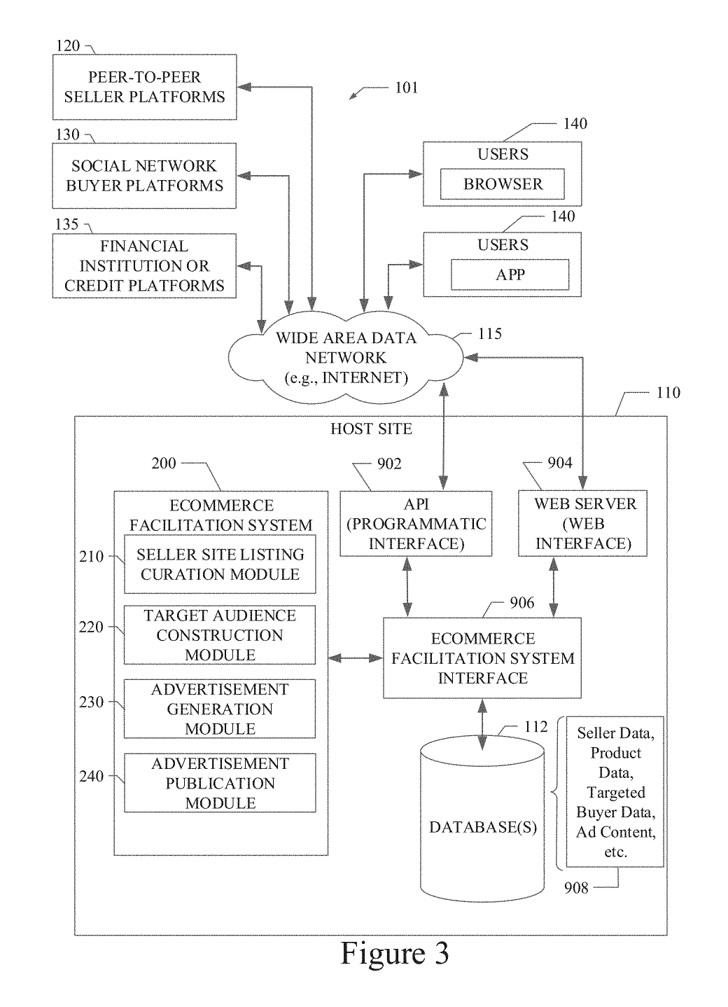

Referring now to FIG. 3, another example embodiment 101 of a networked system in which various embodiments may operate is illustrated. In the embodiment illustrated, the host site 110 is shown to include the ecommerce facilitation system 200. The ecommerce facilitation system 200 is shown to include the functional components 210-240, as described above. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the ecommerce facilitation system 200 either directly or via an interface 906. The ecommerce facilitation system 200 may be configured to access a data storage device 112 either directly or via the interface 906.

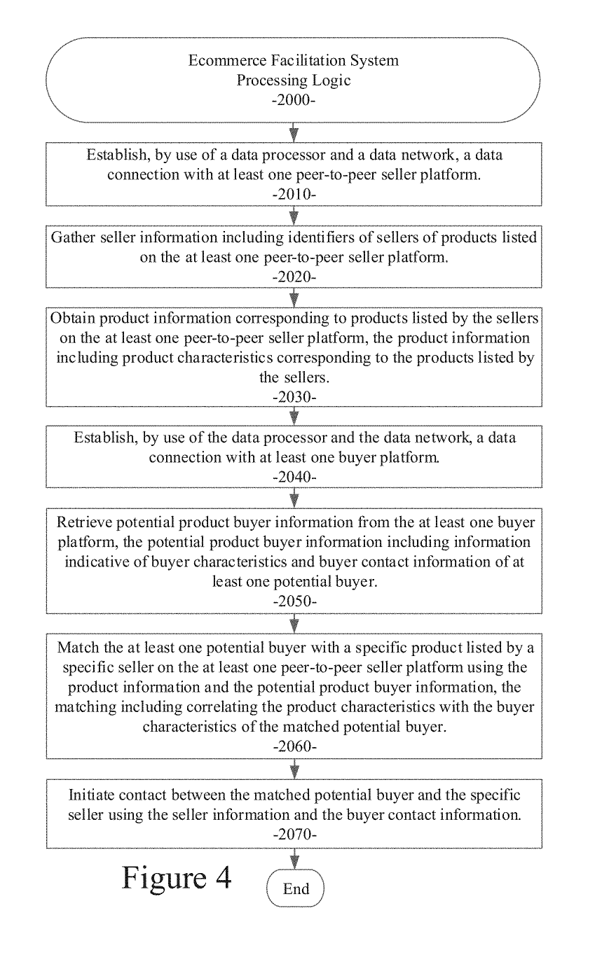

Referring now to FIG. 4, a processing flow diagram illustrates an example embodiment of a method implemented by the ecommerce facilitation system 200 as described herein. The method 2000 of an example embodiment includes: establishing, by use of a data processor and a data network, a data connection with at least one peer-to-peer seller platform (processing block 2010); gathering seller information including identifiers of sellers of products listed on the at least one peer-to-peer seller platform (processing block 2020); obtaining product information corresponding to products listed by the sellers on the at least one peer-to-peer seller platform, the product information including product characteristics corresponding to the products listed by the sellers (processing block 2030); establishing, by use of the data processor and the data network, a data connection with at least one buyer platform (processing block 2040); retrieving potential product buyer information from the at least one buyer platform, the potential product buyer information including information indicative of buyer characteristics and buyer contact information of at least one potential buyer (processing block 2050); matching the at least one potential buyer with a specific product listed by a specific seller on the at least one peer-to-peer seller platform using the product information and the potential product buyer information, the matching including correlating the product characteristics with the buyer characteristics of the matched potential buyer (processing block 2060); and initiating contact between the matched potential buyer and the specific seller using the seller information and the buyer contact information (processing block 2070).

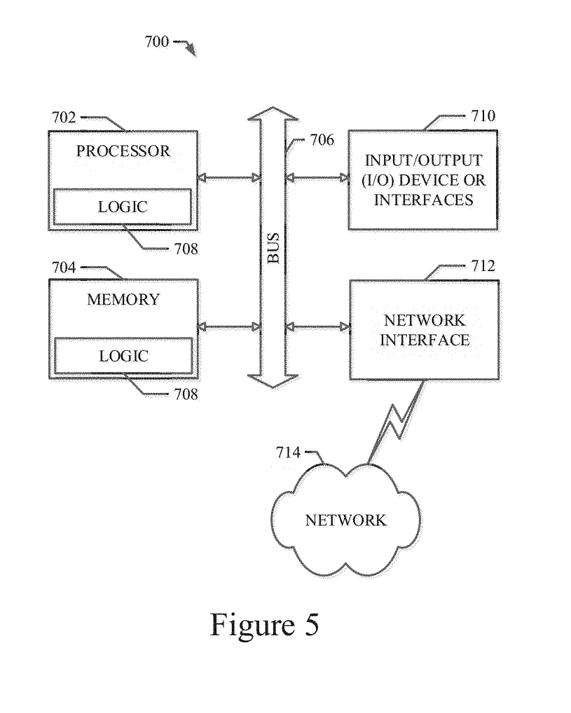

FIG. 5 shows a diagrammatic representation of a machine in the example form of a mobile computing and/or communication system 700 within which a set of instructions when executed and/or processing logic when activated may cause the machine to perform any one or more of the methodologies described and/or claimed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The mobile computing and/or communication system 700 may further include various input/output (I/O) devices and/or interfaces 710, such as a touchscreen display, an audio jack, and optionally a network interface 712. In an example embodiment, the network interface 712 can include one or more radio transceivers configured for compatibility with any one or more standard wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth™, IEEE 802.11x, and the like. In essence, network interface 712 may include or support virtually any wired and/or wireless communication mechanisms by which information may travel between the mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that stores the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

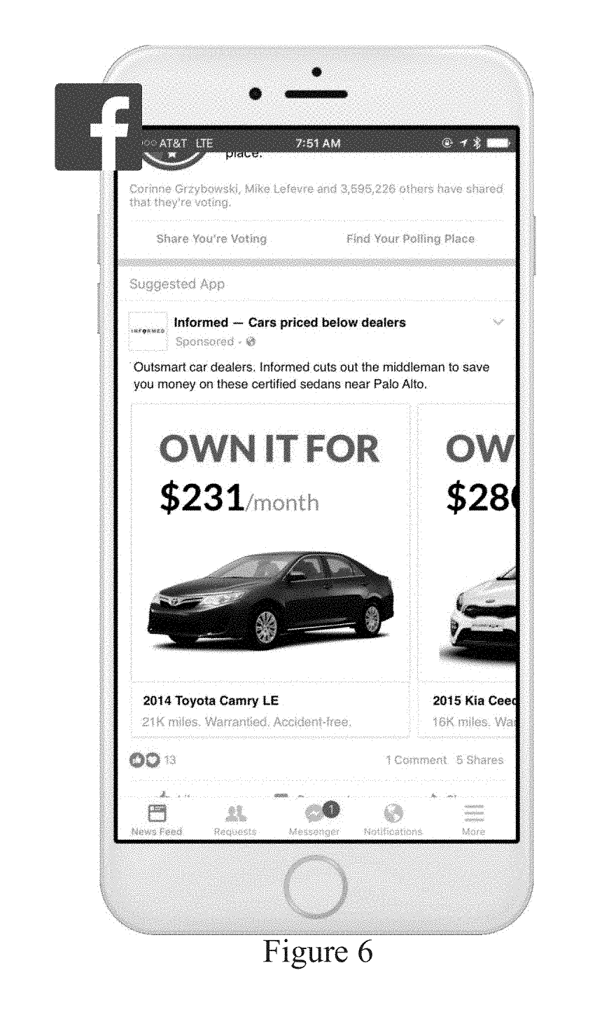

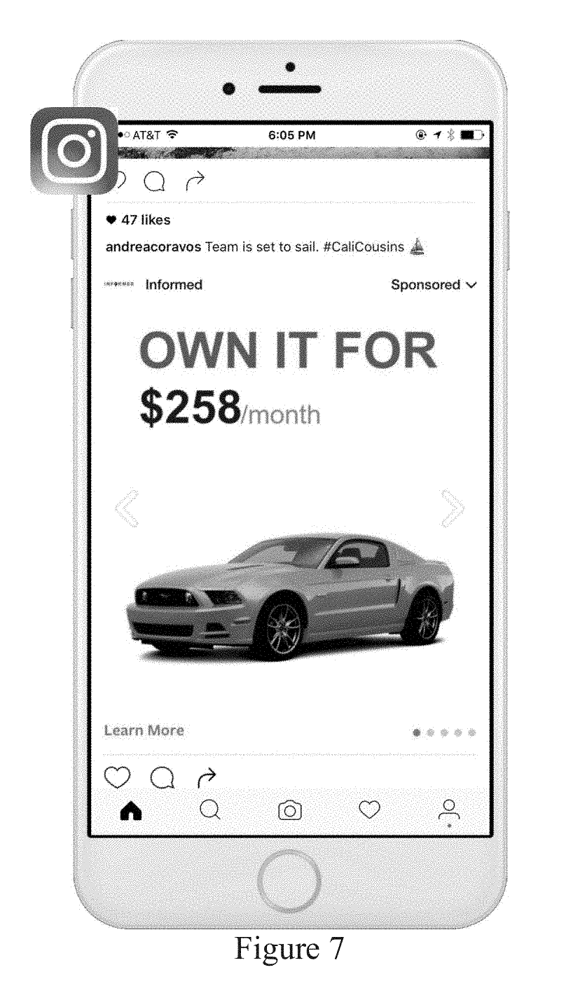

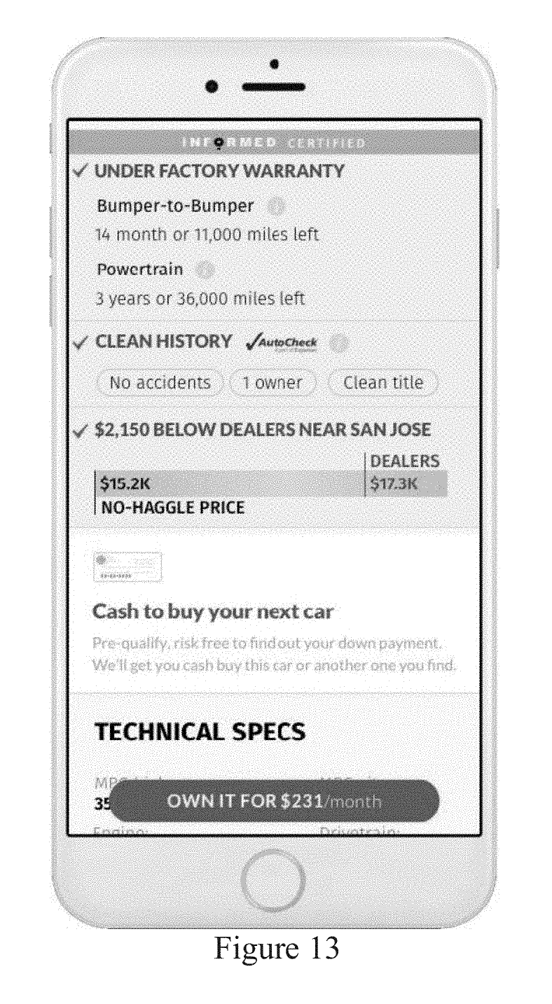

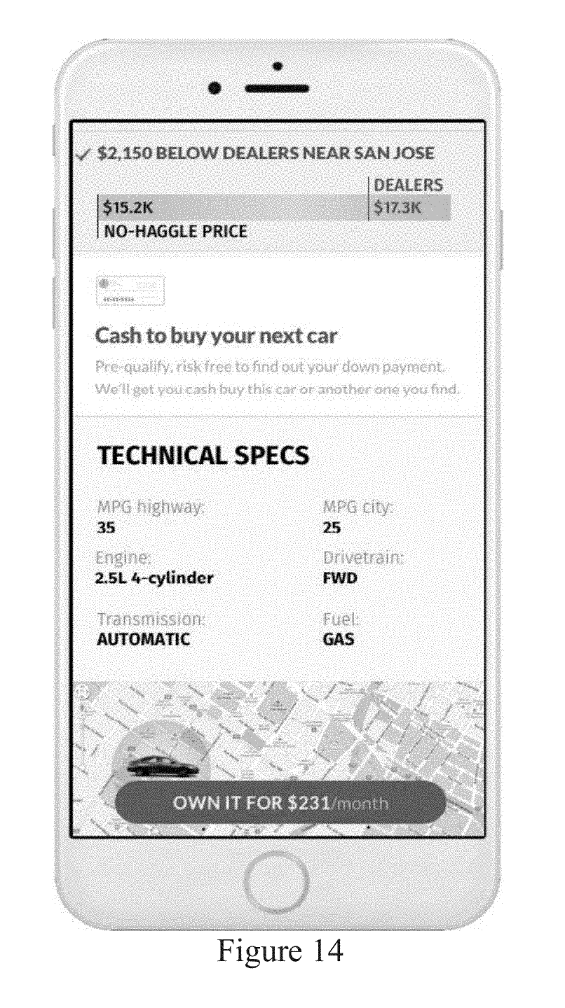

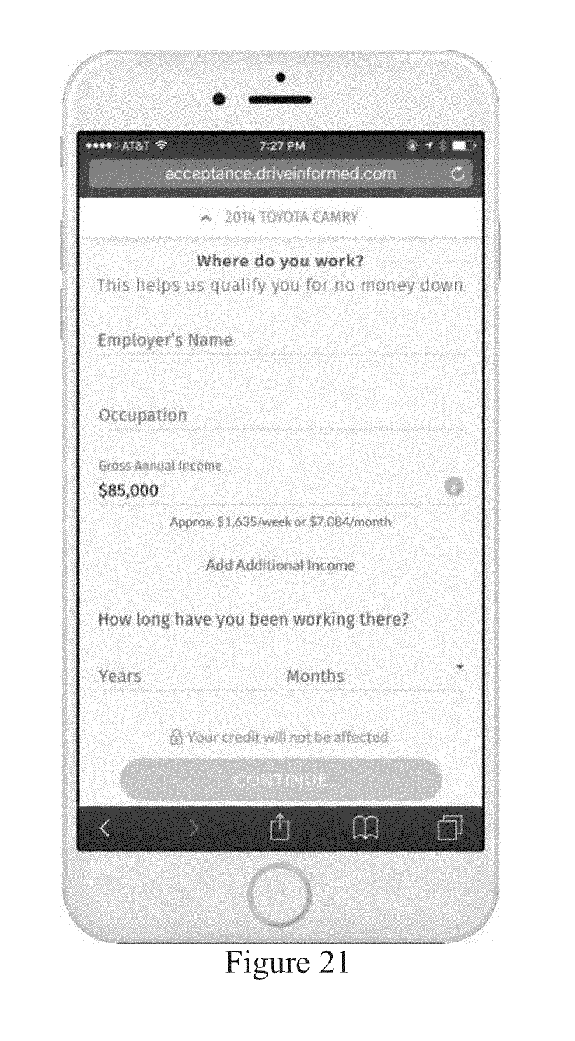

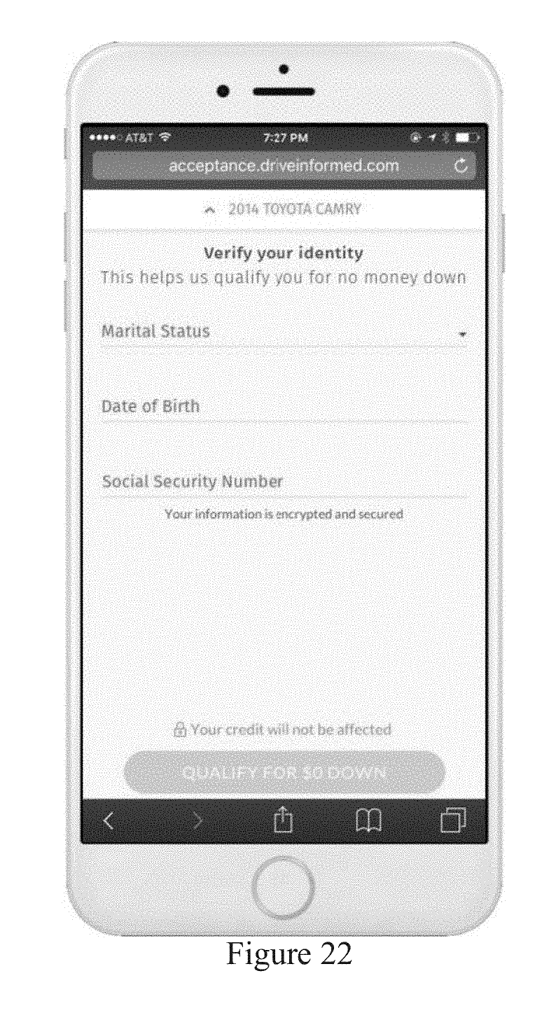

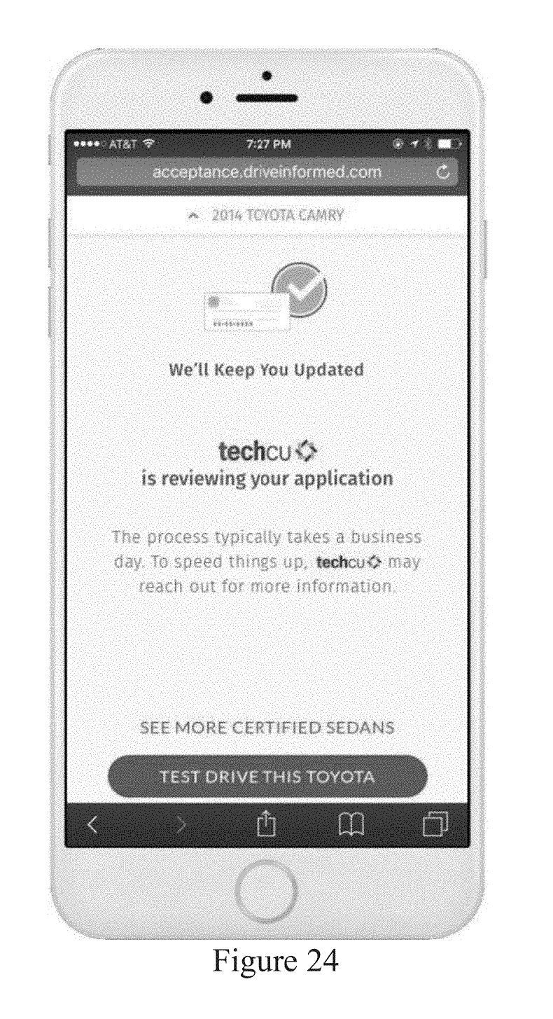

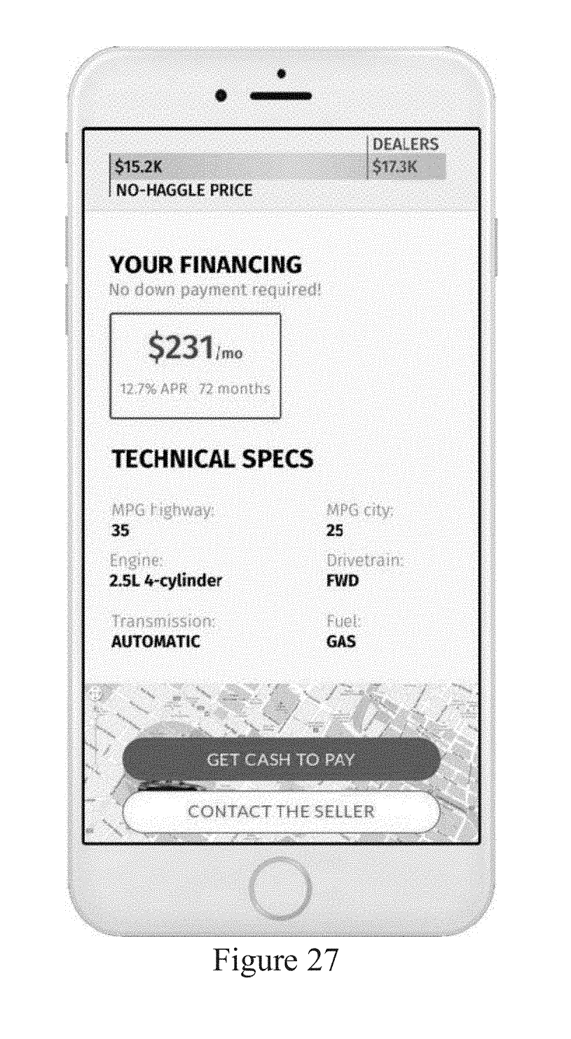

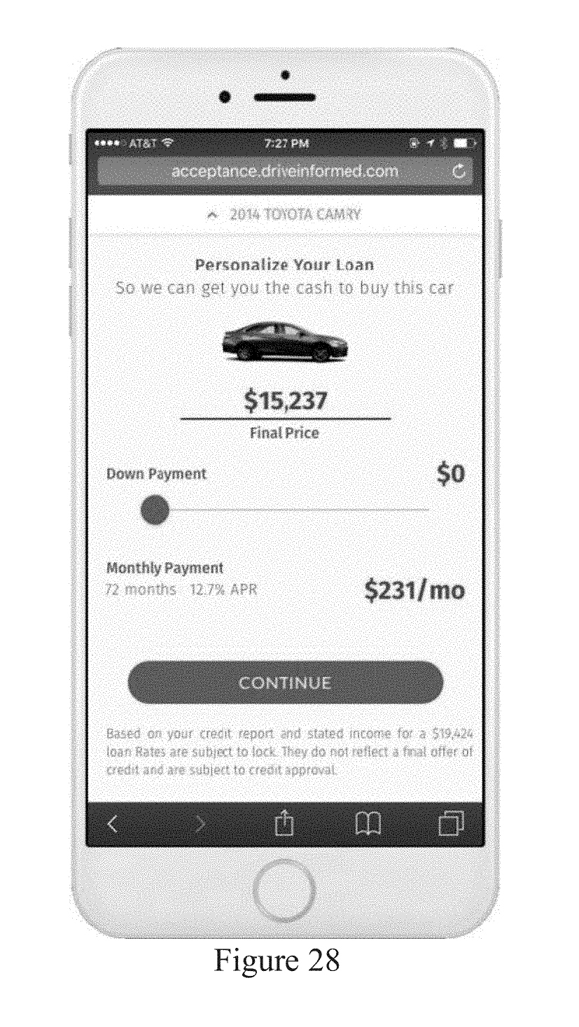

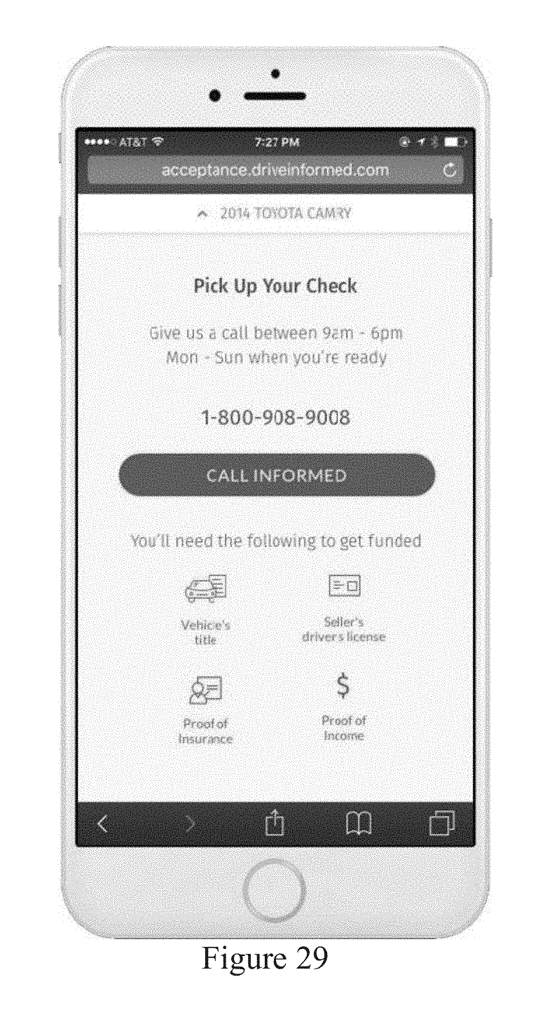

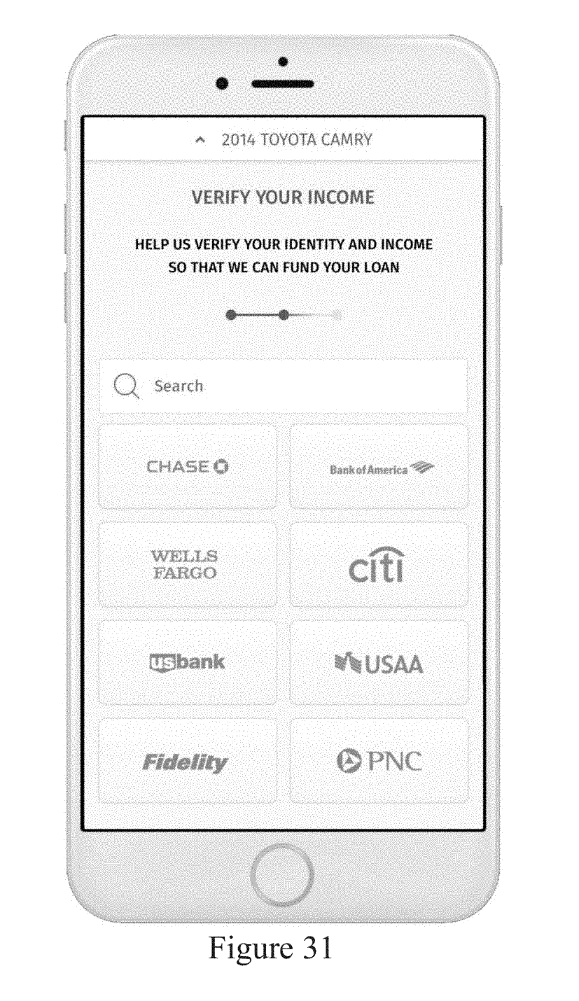

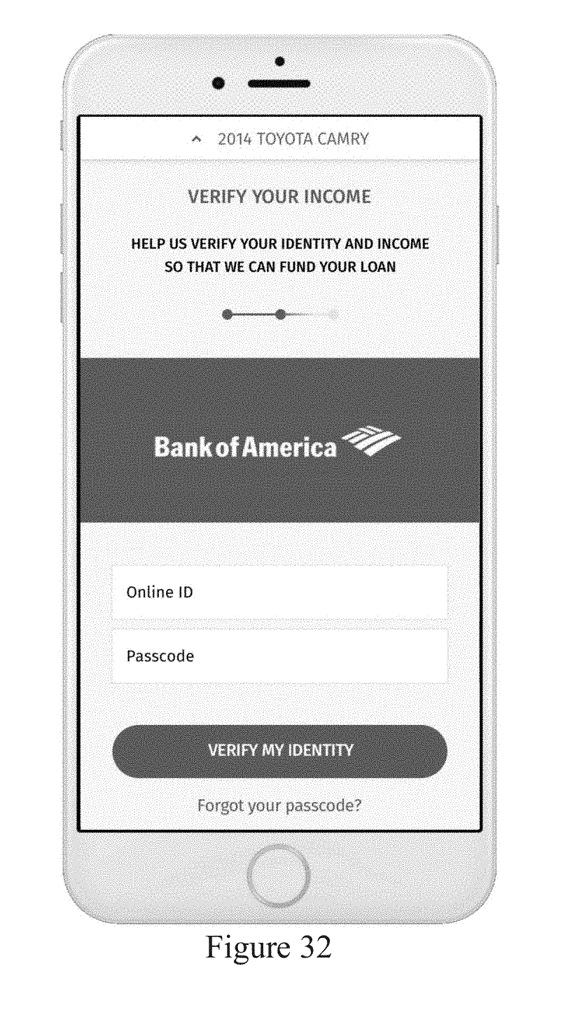

FIGS. 6 through 33 illustrate various example user interface screen snapshots, implemented as a mobile device application, that show the basic elements of the user interface for displaying data and receiving user inputs associated with the cross platform product listing curation system with social network integration in an example embodiment. Referring to FIGS. 6 and 7, the ecommerce facilitation system 200 of an example embodiment can enable social media users and vehicle buyers to discover vehicles for which the social media users are likely to have an affinity based on being associated with a programmatically generated target or custom audience of users of the network resources 130 (e.g., Facebook™, etc.) and associated social networking properties based on shared characteristics as described above. For example, users engaged with or browsing Facebook™ and Instagram™, for example, can be shown targeted advertisements displaying vehicles listed for sale that meet the particular user's explicitly provided profile or implicitly determined affinity based on user behavior. As shown in FIG. 6, a user engaged with Facebook™ can be shown a targeted ad for a 2014 Toyota™ Camry™. The targeted ad and the particular vehicle shown were specifically selected from the curated, searchable sales inventory database based on a comparison of the products offered for sale and the characteristics and affinity of the particular user engaged with the Facebook™ social media site, for example. As shown in FIG. 7, a user engaged with Instagram™ can be shown a targeted ad for a vehicle offered for sale that is likely of interest to the particular user based on the comparison of the inventory of products offered for sale and the characteristics and affinity of the particular user engaged with the Instagram™ social media site. As such, social media users can be shown targeted ads by the ecommerce facilitation system 200 with a high likelihood of interest by the particular users while the users are browsing a social media site and not necessarily actively engaged at the moment in vehicle shopping or searching activities. The targeted ads can show images of particular vehicles of interest and actual related pricing. The targeted ads can also provide links to enable a user to seek more information on the offered vehicle.

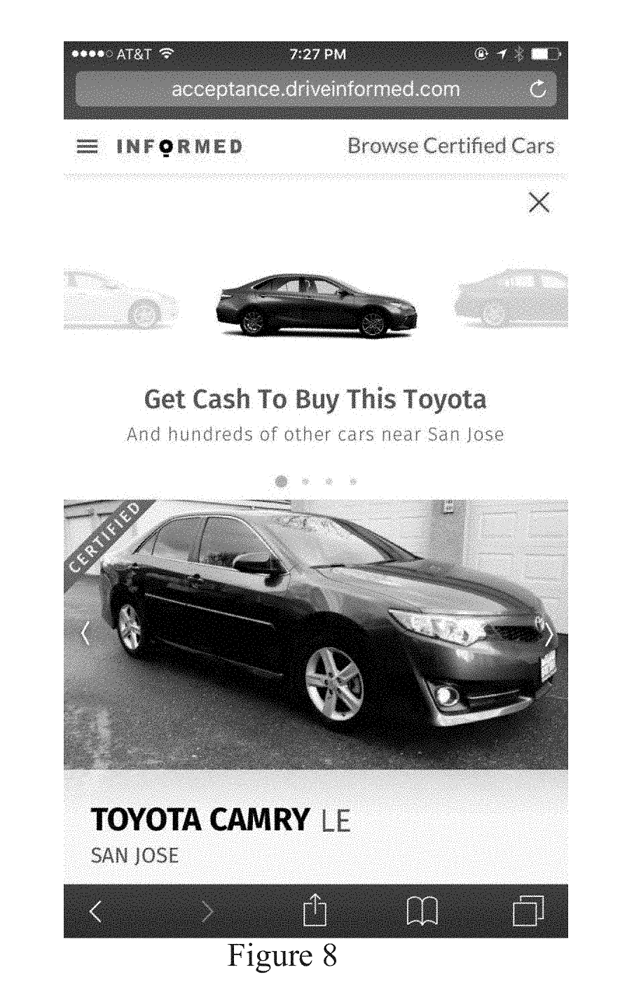

Referring to FIGS. 8 through 11, unlike traditional vehicle ads, the targeted ads automatically shown to users engaged with a social media site can include a variety of information that is specific to a particular unique vehicle or product offered for sale by a private party or a dealer. In the example targeted ad shown in FIG. 8, the user is shown a photo of a particular vehicle offered for sale, the year of manufacture, and the current mileage of the vehicle. Additionally as part of the targeted ad, the user can be offered or prompted with user input objects the user can select to get additional information on the specific vehicle, such as special or custom features and equipment provided with the vehicle. The user can also be shown one or more prices or valuations associated with the specific vehicle offered for sale. The vehicle prices or valuations can be automatically generated by the ecommerce facilitation system 200. For example, the ecommerce facilitation system 200 can automatically access one or more of a plurality of on-line financial institutions, credit platforms, valuation sites, or other 3^{rd} party sites 135. These types of on-line financial institution sites, consumer data or credit reporting sites, and product valuation or rating sites 135 are well-known to those of ordinary skill in the art. The ecommerce facilitation system 200 can be configured to automatically obtain vehicle pricing or valuation information in a digital or computer-readable form from one or more of the on-line financial institutions, credit platforms, valuation sites, or other 3^{rd} party sites 135 via the data network 115. This automatically obtained information can be used to populate the price or valuation information in the targeted ad presented to the particular social media site user. The price or valuation information can also be shown as a monthly payment amount based on a typical interest rate and a typical term of the payment period. The monthly payment amount can also be based on actual vehicle loan terms obtained automatically from one or more of the on-line financial institutions, credit platforms, or valuation sites 135 via the network 115. As such, the particular user can be presented with actual pricing information for a specific vehicle of likely interest.

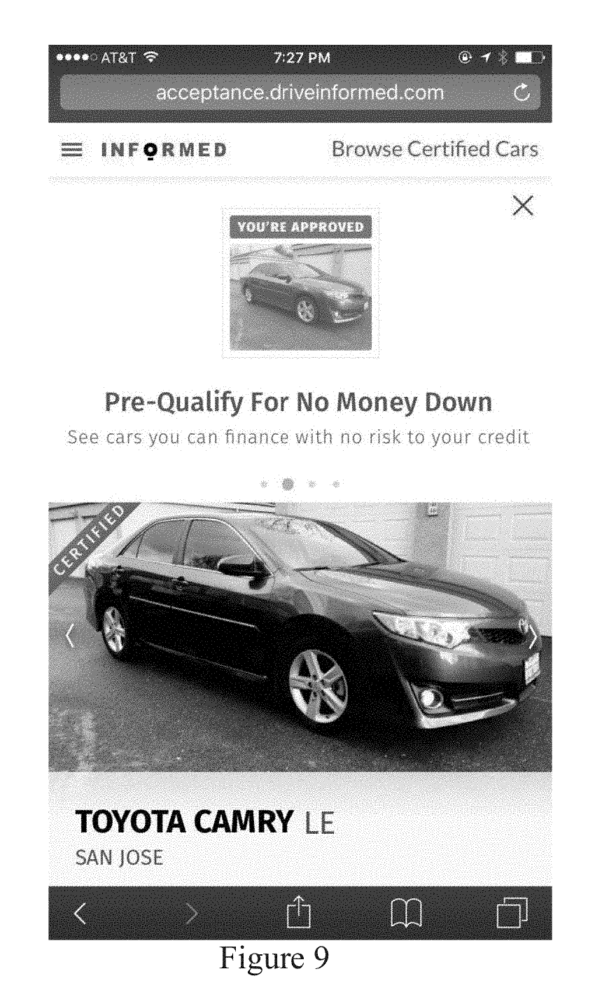

In the example targeted ad shown in FIG. 9, the particular user can be presented with an option to automatically receive a pre-qualification for financing the purchase of the specific vehicle. The ecommerce facilitation system 200 can be configured to automatically obtain credit or payment history information for the particular user as credit information in a digital or computer-readable form from one or more of the on-line financial institutions, credit platforms, valuation sites, or 3^{rd} party sites 135 via the network 115. The information and authorization to automatically obtain the user's credit information can be provided explicitly by the user or provided through a pre-configured user profile. This automatically obtained credit information can be used to compare the particular user's credit history and credit score with the qualifications needed for particular terms of a corresponding vehicle purchase loan, financing, or payment installment plan. The terms of the financing matched with the particular user's credit information can be used to populate the financing information in the targeted ad presented to the particular social media site user.

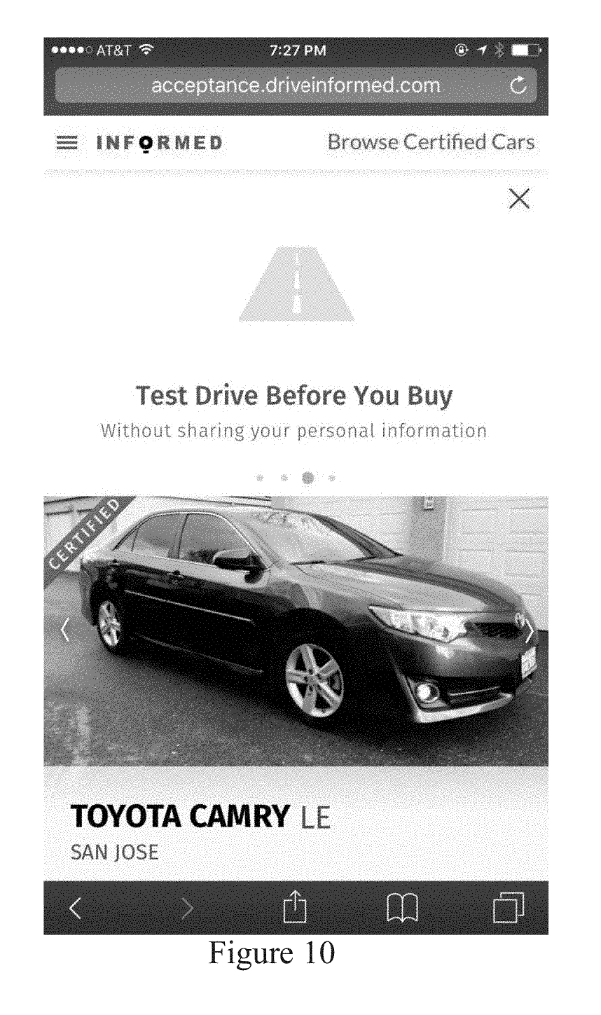

In the example targeted ad shown in FIG. 10, the particular user can be presented with an option to schedule a test drive of the specific vehicle offered for sale. Upon selection of the test drive option by the particular user, the ecommerce facilitation system 200 can be configured to automatically send a text message (e.g., SMS), send an email, or make a phone call to a representative of the seller of the vehicle. The communication between the potential vehicle buyer and the seller can be anonymized to protect the identity of both parties. In this manner, the potential buyer and the seller representative can communicate to discuss the specific vehicle, discuss the purchase terms, and to arrange a place and time for a test drive of the specific vehicle offered for sale.

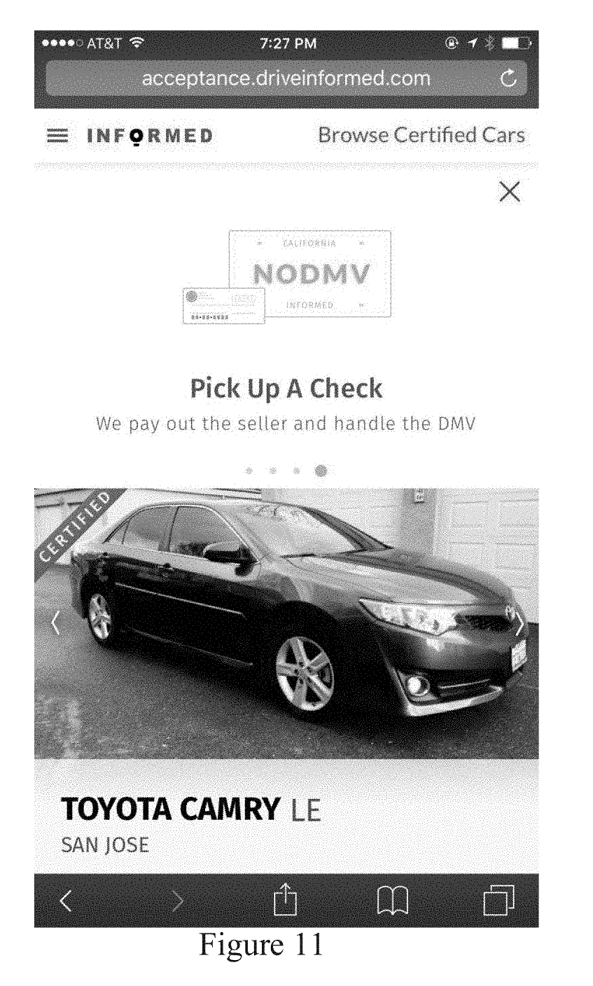

In the example targeted ad shown in FIG. 11, the particular user can be presented with an option to enable the ecommerce facilitation system 200 to automatically process all of the legal documents necessary to legally transfer ownership/title of the specific vehicle offered for sale from the seller to the buyer. The ecommerce facilitation system 200 can also automatically process all of the legal documents necessary to register the vehicle with State authorities in the name of the buyer and/or lender. Upon selection of the option by the particular user to automatically process legal documents, the ecommerce facilitation system 200 can be configured to automatically generate the necessary documents for the specific vehicle in the relevant jurisdiction. The ecommerce facilitation system 200 can be configured to automatically obtain current title and registration information for the specific vehicle as vehicle title/registration information in a digital or computer-readable form from one or more of the on-line financial institutions, credit platforms, valuation sites, or 3^{rd} party sites 135 via the network 115. These 3^{rd} party networked information resources can include State Departments of Motor Vehicles or other State agencies responsible for maintaining vehicle title and registration records. The vehicle title/registration information can be used by the ecommerce facilitation system 200 to automatically prepare the necessary documents for transfer of title and registration of the specific vehicle in the relevant jurisdiction. The automatically prepared documents can be sent by the ecommerce facilitation system 200 to an authorized seller representative via a text message (e.g., SMS), an email, or other electronic means for signature/execution by a representative of the seller of the vehicle. If necessary, legal documents can also be automatically generated and sent to the vehicle buyer for signature/execution by the buyer. Upon receipt of the executed documents from the authorized seller representative and the buyer, the ecommerce facilitation system 200 can be configured to automatically forward the executed title and registration documents, any other related documents, and related payments to the appropriate State agency for recordation. As a result, the entire process of transferring title and registering a specific vehicle can be performed automatically via an electronic device with the ecommerce facilitation system 200 of an example embodiment and a data network. The various embodiments as described herein, therefore, are necessarily rooted in computer and network technology and serve to improve these technologies when applied in the manner as presently claimed.

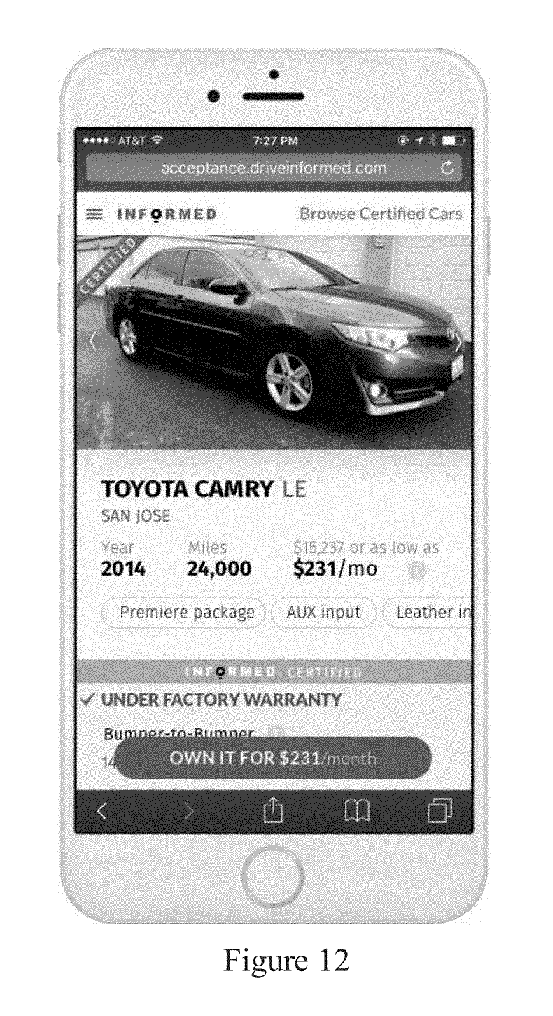

Referring to FIGS. 12 through 14, the ecommerce facilitation system 200 of an example embodiment can present targeted ads to likely buyers as described above. Moreover, the ecommerce facilitation system 200 can automatically access one or more of a plurality of on-line financial institutions, credit platforms, valuation sites, or 3^{rd} party sites 135 to populate the targeted ad with up-to-date information associated with the specific vehicle offered for sale. For example, 3^{rd} party sites 135 can include Experian™, AutoCheck™, and Kelley Blue Book™, to name a few. These types of 3^{rd} party sites are well-known to those of ordinary skill in the art. However, the automatic access of these sites to populate the information in a targeted ad for a likely buyer is not well-known. The ecommerce facilitation system 200 can be configured to automatically obtain, for example, vehicle pricing or valuation information, specific vehicle condition, vehicle certifications, vehicle reviews, specific vehicle repair or accident history, vehicle warranty information, vehicle recall information, vehicle technical specifications and performance information, vehicle rebate or discount information, information on vehicles related or similar to the specific vehicle of interest, and the like, in a digital or computer-readable form from one or more of the on-line 3^{rd} party sites 135 via the network 115. The particular 3^{rd} party sites 135 automatically accessed by the ecommerce facilitation system 200 can be pre-defined and configured. This automatically obtained information can be used to populate the content of the targeted ad presented to the particular social media site user. As such, the particular user can be presented with actual up-to-date information related to a specific vehicle of likely interest. In this way, buyers can be assured that that the specific vehicle shown in the targeted ad is priced fairly and is accident-free by virtue of the information automatically obtained from the 3^{rd} party sites via data network 115.

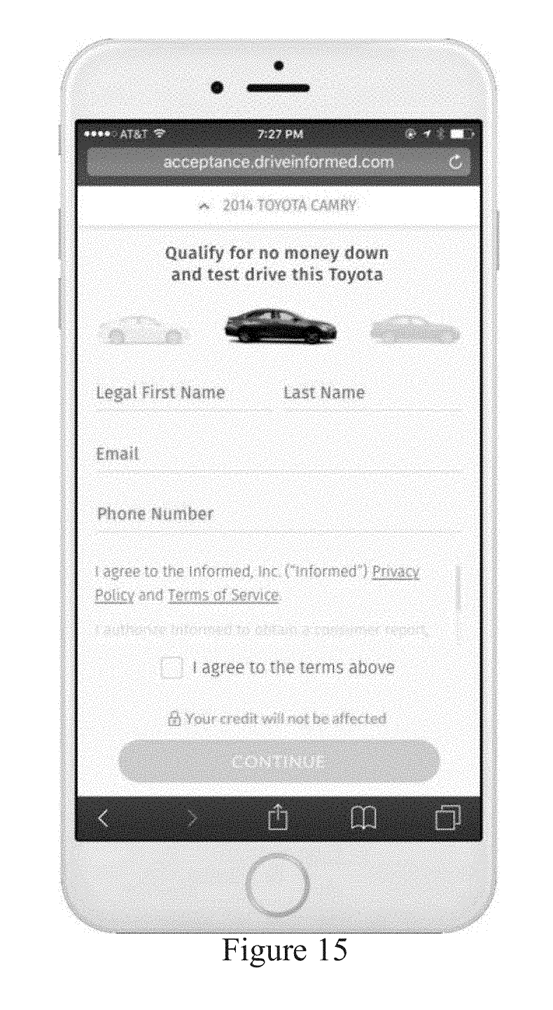

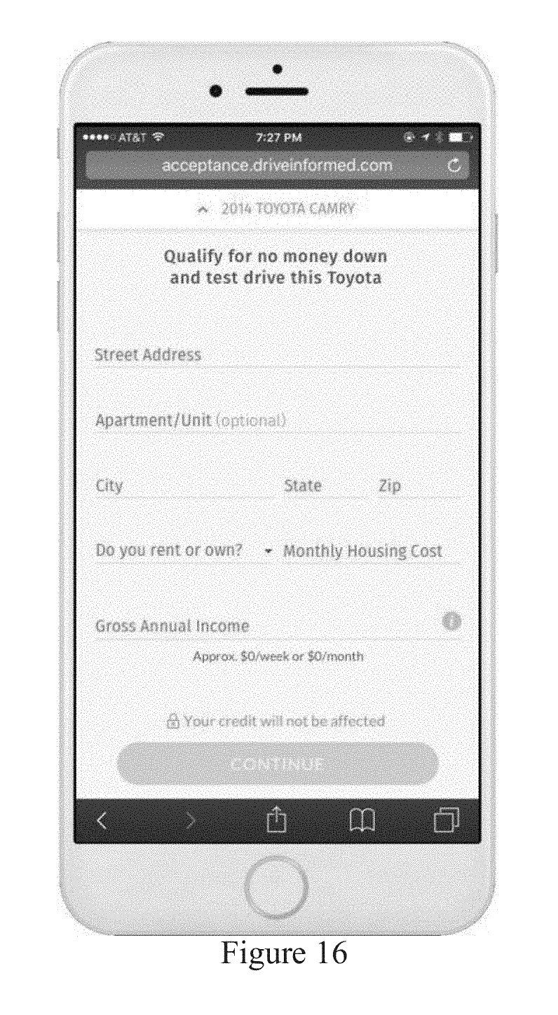

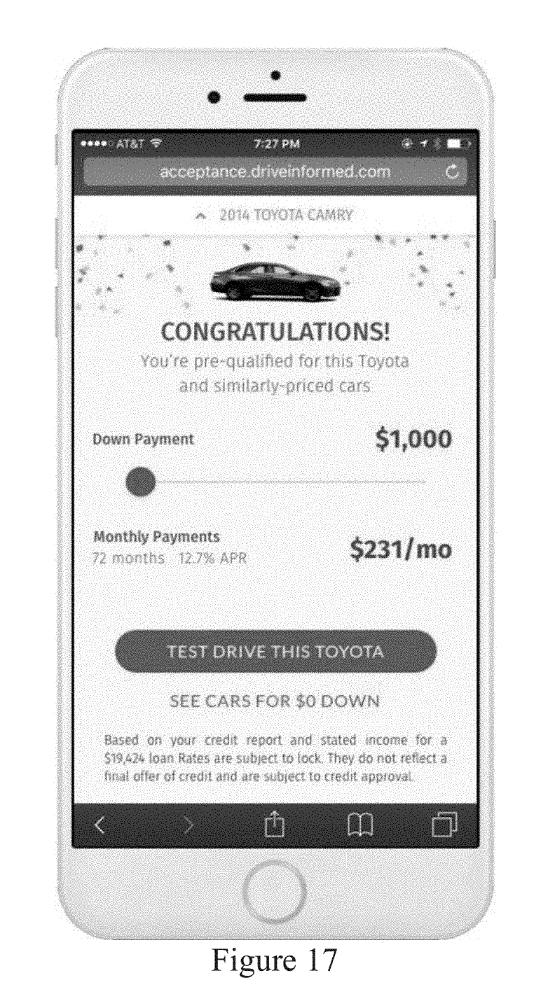

Referring to FIGS. 15 through 17, the particular user/potential buyer can be presented with an option to automatically receive a pre-qualification for financing the purchase of the specific vehicle. The ecommerce facilitation system 200 can be configured to automatically obtain credit and payment history information for the particular user as credit information in a digital or computer-readable form from one or more of the on-line financial institutions, credit platforms, valuation sites, or 3^{rd} party sites 135 via the network 115. The information and authorization to automatically obtain the user's credit information can be provided explicitly by the user or provided through a pre-configured user profile. In an example embodiment shown in FIGS. 15 and 16, the user interface shown to the user can prompt the user to enter information needed to automatically run the user's credit report. This automatically obtained credit information can be used to compare the particular user's credit history and credit score with the qualifications needed for particular terms of a corresponding vehicle purchase loan, financing, or payment installment plan. As shown in FIG. 17, the terms of the financing matched with the particular user's credit information can be used to populate the financing information in the targeted ad presented to the particular social media site user.

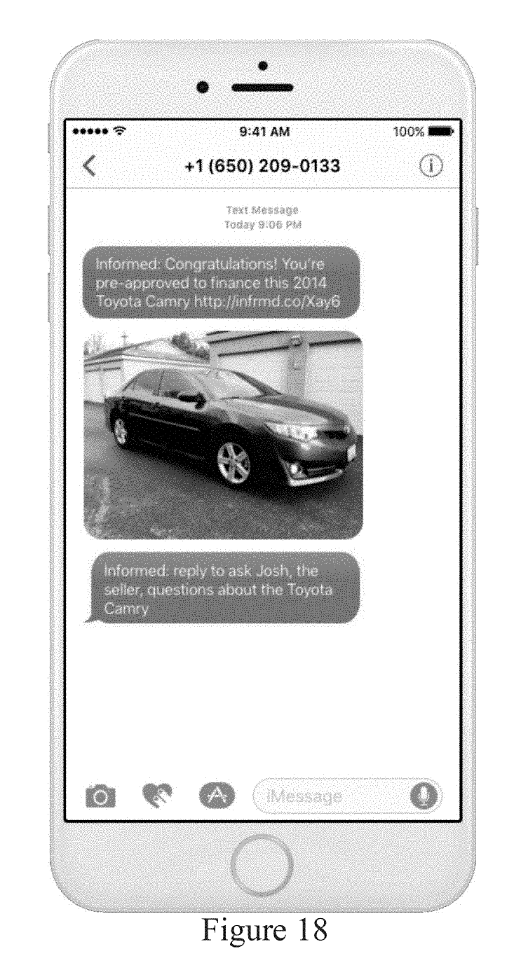

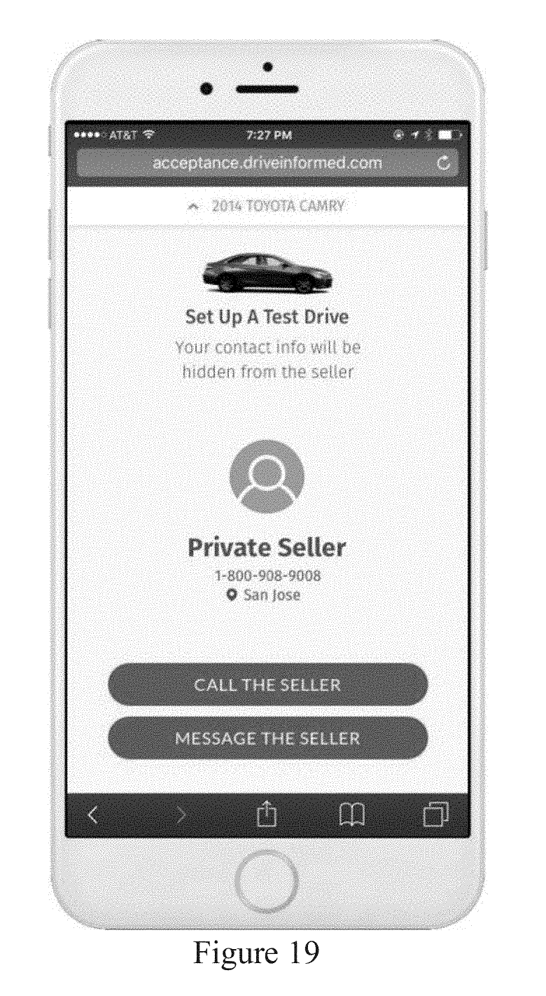

In the example mobile device user interface shown in FIG. 17, the particular user can be presented with an option to schedule a test drive of the specific vehicle offered for sale. Upon selection of the test drive option by the particular user, the ecommerce facilitation system 200 can be configured to automatically send a text message (e.g., SMS), send an email, or make a phone call to a representative of the seller of the vehicle (e.g., see FIGS. 18 through 19). The communication between the potential vehicle buyer and the seller can be anonymized to protect the identity of both parties. In this manner, the potential buyer and the seller representative can communicate to discuss the details of the specific vehicle, discuss the terms of the purchase, and arrange a place and time for a test drive of the specific vehicle offered for sale. Because of the anonymized communication made possible by the ecommerce facilitation system 200, the parties can communicate without having to share contact information.

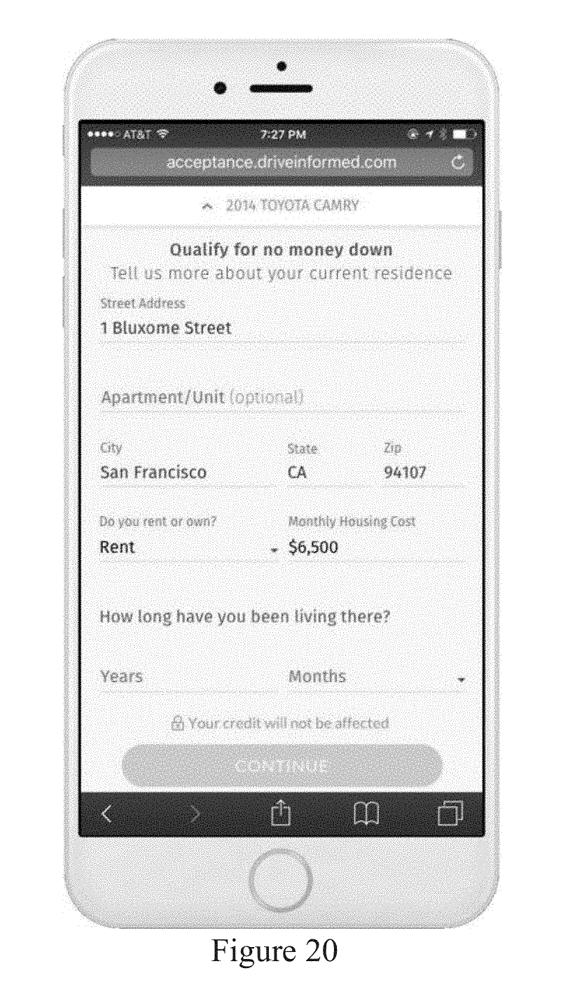

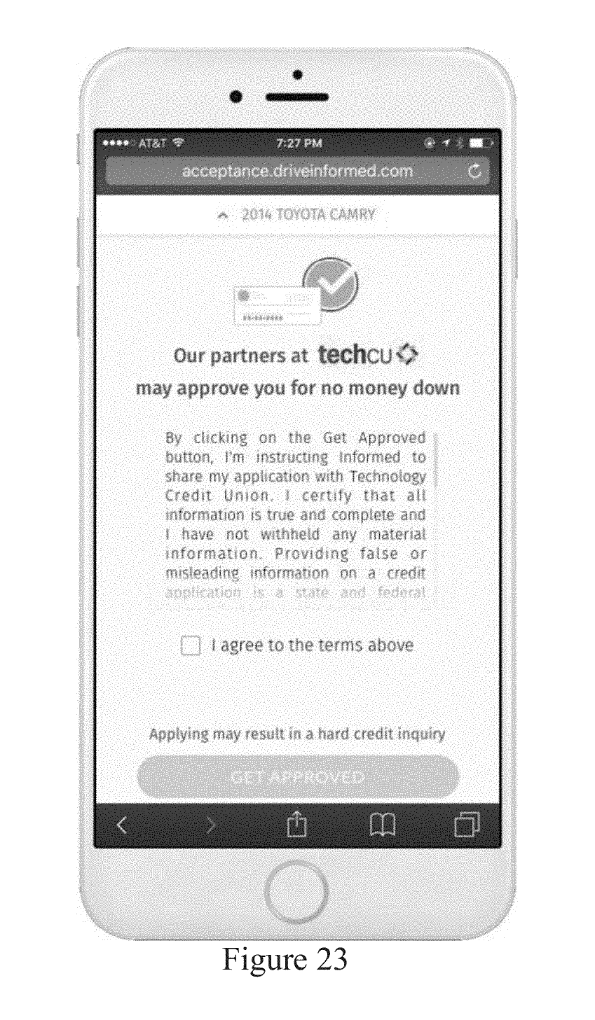

Referring to FIGS. 20 through 25, the particular user/potential buyer can use an electronic device, such as a mobile phone 144, to initiate an application for a vehicle purchase loan, installment agreement, or other purchase financing by use of the user interface and automatic network communications provided by the ecommerce facilitation system 200 of an example embodiment. As shown in FIGS. 20 through 22, the user can be prompted for a variety of information related to the application for vehicle purchase financing. The ecommerce facilitation system 200 can be configured to only prompt the user for information not received earlier during a loan pre-qualification process as described above. The vehicle purchase financing information for the user can be collected and compiled by the ecommerce facilitation system 200 into an application form suitable for a specific lending institution. Depending on the location of the parties, the location of the vehicle, the loan amount, the buyer's credit information, the availability of capital, etc., the ecommerce facilitation system 200 can automatically select one or more lending institutions for submittal of the vehicle purchase financing application. As shown in FIG. 23, the user can be prompted for authorization for the ecommerce facilitation system 200 to automatically and electronically submit the collected and compiled vehicle purchase financing application to one or more automatically selected lending institutions appropriate for the buyer's financing needs.

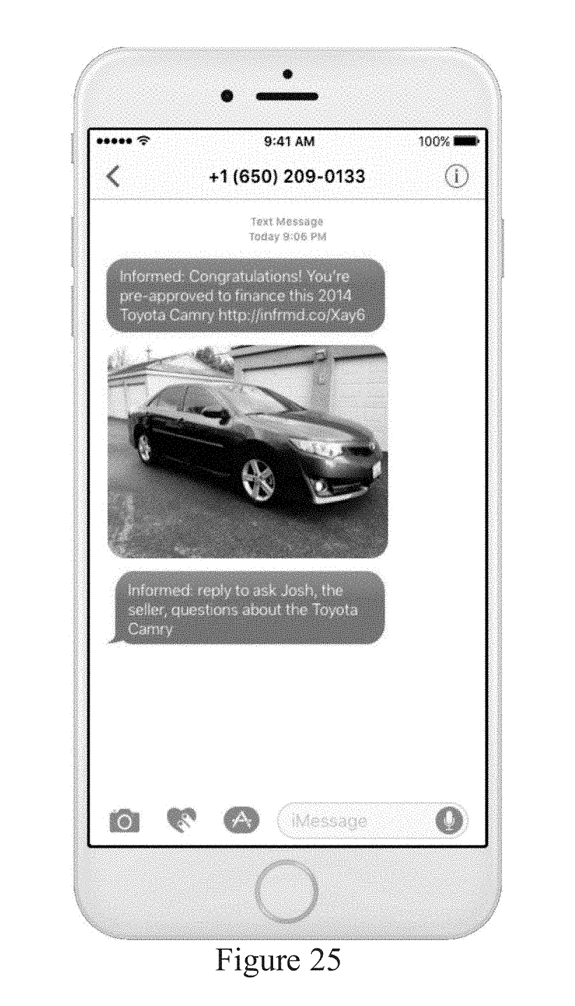

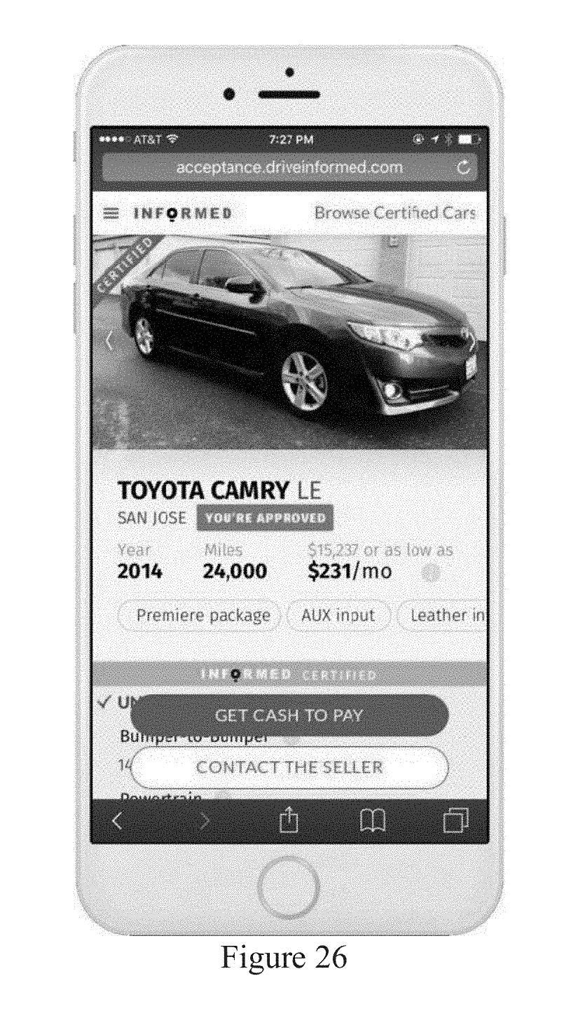

Referring to FIG. 25, the ecommerce facilitation system 200 of an example embodiment can be configured to notify the buyer of the outcome of the vehicle purchase financing application. In this manner, buyers are notified when their loan is approved and they can get cash, a check, or electronic proceeds to complete the vehicle purchase. As shown in FIG. 25, the ecommerce facilitation system 200 can be configured to automatically send a text message (e.g., SMS), send an email, make a phone call, or otherwise communicate with a representative of the buyer of the vehicle to communicate the outcome of the vehicle purchase financing application. As shown in FIGS. 26 through 29, the ecommerce facilitation system 200 can be configured to automatically present to the user, via a user interface on the mobile device, a summary of the final financing terms and to prompt the user for authorization to proceed with the funding of the approved financing.

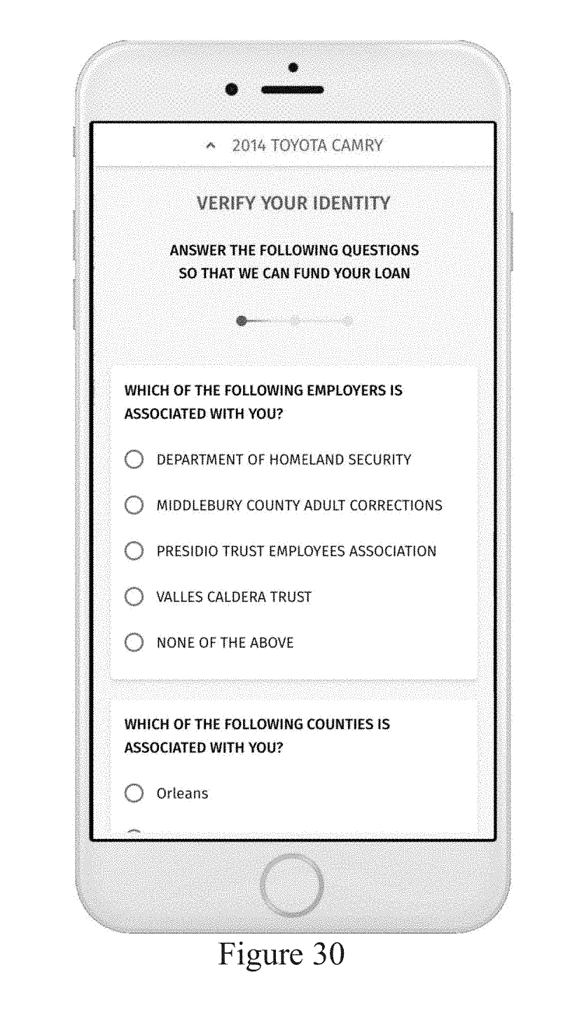

Referring to FIGS. 30 through 32, the user has provided authorization to proceed with the funding of the approved financing via the user interface. In this case, the ecommerce facilitation system 200 can be configured to automatically present to the user, via a user interface on the mobile device, a set of security prompts to verify the identity of the user before the proceeds of the financing are made available. In an example embodiment, the ecommerce facilitation system 200 can be configured to verify the borrower's identity, income, employment, residence location, and the like. As part of this verification process, the ecommerce facilitation system 200 can be configured to automatically obtain various forms of identity verification information for the particular user as identity information in a digital or computer-readable form from one or more of the on-line financial institutions, credit platforms, valuation sites, or other 3^{rd} party sites 135 via the network 115. For example, as shown in FIG. 30, the ecommerce facilitation system 200 can automatically obtain a user profile or credit report for the user by access to a 3^{rd} party site 135. Portions of this automatically obtained identity information can be extracted by the ecommerce facilitation system 200 and used to populate security questions for the user that are presented via the user interface. Similarly, the ecommerce facilitation system 200 can automatically obtain user bank account information by access to a 3^{rd} party site 135. Portions of this automatically obtained bank account information can be extracted by the ecommerce facilitation system 200 and used to populate additional security questions for the user that are presented via the user interface. In this manner, the ecommerce facilitation system 200 can automatically obtain a variety of information from 3^{rd} party sites 135 via the network 115 and use this information to verify the identity of the user prior to funding the loan for the user.

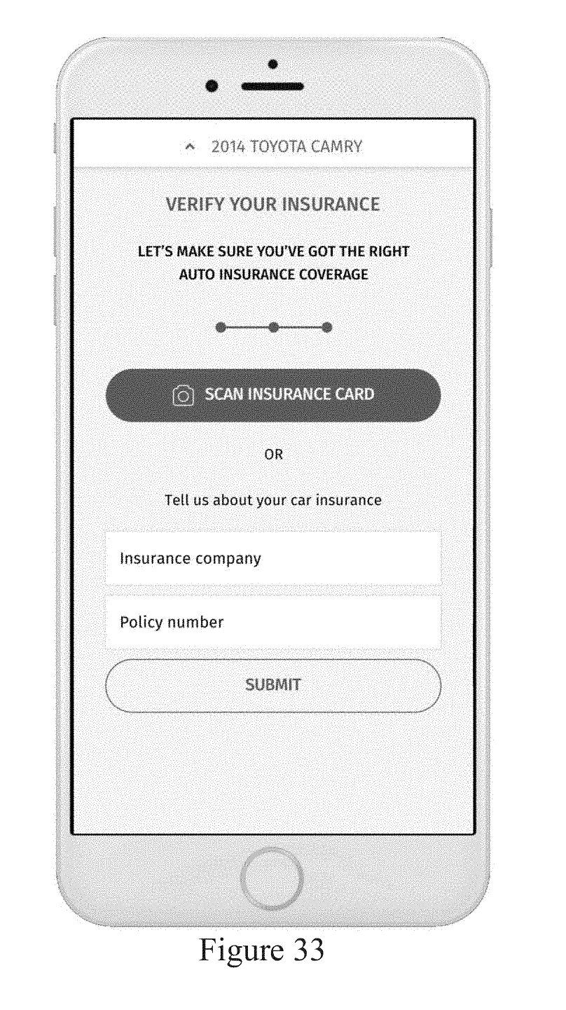

Referring now to FIG. 33, the particular user can be presented with an option to automatically apply for insurance coverage for a newly-purchased specific vehicle. The ecommerce facilitation system 200 can be configured to automatically obtain insurance information, insurance quotes, and the like for the particular user and specific vehicle as insurance information in a digital or computer-readable form from one or more of the on-line insurance institutions, insurance brokers, underwriters, or other insurance-related sites 135 via the network 115. The information and authorization to automatically obtain insurance information and quotes can be provided explicitly by the user or provided through a pre-configured user profile. This automatically obtained insurance information can be used to compare the particular user's insurance history, desired coverage limits, the required coverage limits for a creditor/lender, the characteristics and location of the vehicle, etc., with the parameters needed for the particular terms of a corresponding vehicle insurance policy. The terms of the vehicle insurance policy matched with the particular user's insurance information and the details of the specific vehicle can be used to populate insurance information in a user interface presented to the particular social media site user. The user can also be presented with one or more insurance coverage options with related pricing and prompted to select a desired option. Upon selection of a desired insurance option, the ecommerce facilitation system 200 can be configured to automatically forward the user's selection and the related insurance information to the appropriate insurance carrier so the coverage can be bound for the user.

As described herein for various example embodiments, a system and method for cross platform product listing curation with social network integration are disclosed. In various embodiments, a software application program is used to enable the development and presentation of product listings for targeted buyer groups or audiences on the display screen of a computing or communication system, including mobile devices. As described above, in a variety of contexts, the ecommerce facilitation system 200 of an example embodiment can be configured to automatically obtain a variety of information from one or more 3^{rd} party sites via a data network to facilitate the user experience of searching, purchasing, financing, test driving, transferring title, registering, and insuring a specific vehicle, all from the convenience of a portable electronic device, such as a smartphone. This collection of vehicle-related transactions has traditionally been possible only via multiple, personal interactions with a plurality of different parties at different locations. The embodiments as presently disclosed and claimed enable these disparate transactions to be integrated into a single set of electronic interactions with a mobile device or other computing device. As such, the various embodiments as described herein are necessarily rooted in computer and network technology and serve to improve these technologies when applied in the manner as presently claimed. In particular, the various embodiments described herein improve the use of mobile device technology and data network technology in the context of product purchase transactions via electronic means.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method comprising:
establishing, by use of a data processor and a data network, a data connection with at least one peer-to-peer seller platform;
gathering seller information including identifiers of sellers of products listed on the at least one peer-to-peer seller platform;
obtaining product information corresponding to products listed by the sellers on the at least one peer-to-peer seller platform, the product information including product characteristics corresponding to the products listed by the sellers;
establishing, by use of the data processor and the data network, a data connection with at least one buyer platform;
retrieving potential product buyer information from the at least one buyer platform, the potential product buyer information including information indicative of buyer characteristics and buyer contact information of at least one potential buyer;
matching the at least one potential buyer with a specific product listed by a specific seller on the at least one peer-to-peer seller platform using the product information and the potential product buyer information, the matching including correlating the product characteristics with the buyer characteristics of the matched potential buyer; and
initiating contact between the matched potential buyer and the specific seller using the seller information and the buyer contact information.

2. The method of claim 1 further including:
using the potential product buyer information to determine characteristics of products of interest to a specific potential product buyer;
generating a retained data object including information indicative of the characteristics of products of interest to the specific potential product buyer; and
placing the retained data object on a user client device of the specific potential product buyer.

3. The method of claim 1 further including:
using the potential product buyer information to determine characteristics of products of interest to groups of potential product buyers; and
generating a custom audience data set including information indicative of the characteristics of products of interest to the groups of potential product buyers.

4. The method of claim 3 further including:
creating a product advertisement creative with content corresponding to the characteristics of the custom audience data set and the product information; and
making the product advertisement creative available for display on the buyer platform to a relevant audience as defined by the custom audience data set.

5. The method of claim 4 further including specifying a bid value to pay for each click generated by users corresponding to the custom audience data set as the users view or interact with the product advertisement creative.

6. The method of claim 4 further including collecting information corresponding to clicks generated by users as the users view or interact with the product advertisement creative.

7. The method of claim 4 further including compiling, reporting, and retaining statistics and analytics associated with the product advertisement creative.

8. The method of claim 1 further including:
establishing, by use of the data processor and the data network, a data connection with at least one financial platform;
retrieving potential product buyer financial information from the at least one financial platform, the potential product buyer financial information including information indicative of buyer financing qualifications; and
pre-determining the at least one potential buyer's ability to qualify for financing of the specific product based on the potential product buyer financial information.

9. The claim of claim 1 wherein the at least one buyer platform is a social network platform or other network resource.

10. A system comprising:
a data processor;
a network interface, in data communication with the data processor, for communication on a data network; and
an ecommerce facilitation system, executable by the data processor, to:
establish, by use of the data processor and the data network, a data connection with at least one peer-to-peer seller platform;
gather seller information including identifiers of sellers of products listed on the at least one peer-to-peer seller platform;
obtain product information corresponding to products listed by the sellers on the at least one peer-to-peer seller platform, the product information including product characteristics corresponding to the products listed by the sellers;
establish, by use of the data processor and the data network, a data connection with at least one buyer platform;
retrieve potential product buyer information from the at least one buyer platform, the potential product buyer information including information indicative of buyer characteristics and buyer contact information of at least one potential buyer;
match the at least one potential buyer with a specific product listed by a specific seller on the at least one peer-to-peer seller platform using the product information and the potential product buyer information, the matching including correlating the product characteristics with the buyer characteristics of the matched potential buyer; and
initiate contact between the matched potential buyer and the specific seller using the seller information and the buyer contact information.

11. The system of claim 10 wherein the ecommerce facilitation system being further configured to:
use the potential product buyer information to determine characteristics of products of interest to a specific potential product buyer;
generate a retained data object including information indicative of the characteristics of products of interest to the specific potential product buyer; and
place the retained data object on a user client device of the specific potential product buyer.

12. The system of claim 10 wherein the ecommerce facilitation system being further configured to:
use the potential product buyer information to determine characteristics of products of interest to groups of potential product buyers; and
generate a custom audience data set including information indicative of the characteristics of products of interest to the groups of potential product buyers.

13. The system of claim 12 wherein the ecommerce facilitation system being further configured to:
create a product advertisement creative with content corresponding to the characteristics of the custom audience data set and the product information; and
make the product advertisement creative available for display on the buyer platform to a relevant audience as defined by the custom audience data set.

14. The system of claim 13 wherein the ecommerce facilitation system being further configured to specify a bid value to pay for each click generated by users corresponding to the custom audience data set as the users view or interact with the product advertisement creative.

15. The system of claim 13 wherein the ecommerce facilitation system being further configured to collect information corresponding to clicks generated by users as the users view or interact with the product advertisement creative.

16. The system of claim 13 wherein the ecommerce facilitation system being further configured to compile, report, and retain statistics and analytics associated with the product advertisement creative.

17. The system of claim 10 wherein the ecommerce facilitation system being further configured to:
establish, by use of the data processor and the data network, a data connection with at least one financial platform;
retrieve potential product buyer financial information from the at least one financial platform, the potential product buyer financial information including information indicative of buyer financing qualifications; and
pre-determine the at least one potential buyer's ability to qualify for financing of the specific product based on the potential product buyer financial information.

18. The system of claim 10 wherein the at least one buyer platform is a social network platform or other network resource.

19. A non-transitory machine-useable storage medium embodying instructions which, when executed by a machine, cause the machine to:
establish, by use of a data processor and a data network, a data connection with at least one peer-to-peer seller platform;
gather seller information including identifiers of sellers of products listed on the at least one peer-to-peer seller platform;
obtain product information corresponding to products listed by the sellers on the at least one peer-to-peer seller platform, the product information including product characteristics corresponding to the products listed by the sellers;
establish, by use of the data processor and the data network, a data connection with at least one buyer platform;
retrieve potential product buyer information from the at least one buyer platform, the potential product buyer information including information indicative of buyer characteristics and buyer contact information of at least one potential buyer;
match the at least one potential buyer with a specific product listed by a specific seller on the at least one peer-to-peer seller platform using the product information and the potential product buyer information, the matching including correlating the product characteristics with the buyer characteristics of the matched potential buyer; and
initiate contact between the matched potential buyer and the specific seller using the seller information and the buyer contact information.

20. The non-transitory machine-useable storage medium of claim 19 wherein the at least one buyer platform is a social network platform or other network resource.
